(19) United States
(12) Patent Application Publication
(10) Pub. No.: US 2025/0137792 A1
(43) Pub. Date: May 1, 2025

(54) ROUTE PLANNING SYSTEM FOR A REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/918,665

(22) Filed: Oct. 17, 2024

Related U.S. Application Data
(60) Provisional application No. 63/545,985, filed on Oct. 27, 2023.

(51) Int. Cl. G01C 21/34; B60G 17/015; B65F 1/14; B65F 3/00; G01C 21/36

(52) U.S. Cl. CPC G01C 21/3476; B60G 17/0152; B65F 1/14; B65F 3/00; G01C 21/365; B60G 2400/60; B65F 2210/168

(57) ABSTRACT

A system includes a refuse vehicle, multiple refuse containers, and a remote computing system. The refuse vehicle includes a telematics unit. The refuse containers are positioned at different customer locations. Each of the refuse containers include a sensor configured to measure a fill level and a wireless transceiver. The remote computing system includes processing circuitry configured to obtain a status of the refuse vehicle from the telematics unit. The processing circuitry is also configured to obtain sensor data from the refuse containers indicating the fill level of each of the refuse containers. The processing circuitry is also configured to determine a route for the refuse vehicle based on the status of the refuse vehicle and the sensor data obtained from the refuse containers. The processing circuitry is also configured to transmit the route to the telematics unit of the refuse vehicle.

### CROSS-REFERENCE TO RELATED PATENT APPLICATION

This application claims the benefit of and priority to U.S. Provisional Application No. 63/545,985, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

One embodiment of the present disclosure relates to a system. The system includes a refuse vehicle, multiple refuse containers, and a remote computing system. The refuse vehicle includes a telematics unit. The refuse containers are positioned at different customer locations. Each of the refuse containers include a sensor configured to measure a fill level and a wireless transceiver. The remote computing system includes processing circuitry configured to obtain a status of the refuse vehicle from the telematics unit. The processing circuitry is also configured to obtain sensor data from the refuse containers indicating the fill level of each of the refuse containers. The processing circuitry is also configured to determine a route for the refuse vehicle based on the status of the refuse vehicle and the sensor data obtained from the refuse containers. The processing circuitry is also configured to transmit the route to the telematics unit of the refuse vehicle.

The status provided by the refuse vehicle can include a fill level or payload of the refuse vehicle and a capacity of the refuse vehicle. The processing circuitry of the remote computing system can be configured to obtain historical data indicating an amount of refuse in each of the refuse containers. The processing circuitry can also be configured to determine, based on the historical data, a profile indicating an average amount of refuse in each of the refuse containers and a likelihood that each of the refuse containers are contaminated. The processing circuitry can also be configured to determine the route for the refuse vehicle based on the profile of each of the refuse containers.

The refuse vehicle may include a controller configured to obtain, from the remote computing system, a scheduled deployment time of the refuse vehicle for the route. The controller can also be configured to perform multiple preconditioning operations to ready an oil temperature of a hydraulic system and an environmental condition of a cab of the refuse vehicle by the scheduled deployment time. The refuse containers may form a mesh network.

Another embodiment of the present disclosure is a method of controlling a refuse vehicle. The method includes obtaining a status from the refuse vehicle. The method also includes obtaining sensor data from refuse containers at various geographic locations. The sensor data indicates a fill level of each of the refuse containers. The method also includes determining a route for the refuse vehicle based on the status of the refuse vehicle and the sensor data from the refuse containers. The method also includes prompting a driver of the refuse vehicle to transport the refuse vehicle along the route.

Yet another embodiment of the present disclosure is a system. The system includes a refuse vehicle and processing circuitry. The processing circuitry is configured to obtain a status of the refuse vehicle. The processing circuitry is also configured to obtain a fill level of each of multiple refuse containers. The processing circuitry is also configured to determine a route for the refuse vehicle based on the status of the refuse vehicle and the sensor data from the refuse containers. The processing circuitry is also configured to transmit the route to the refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a diagram illustrating a refuse vehicle equipped with a refuse detection and sorting system, according to an exemplary embodiment;

FIG. 7 is a diagram illustrating different features of a refuse container that are usable by the refuse detection and sorting system of FIG. 6 to infer a type of refuse in the refuse container, according to an exemplary embodiment;

FIG. 8 is a block diagram of the refuse detection and sorting system of FIG. 6, according to an exemplary embodiment;

FIG. 9 is a diagram illustrating a hopper of the refuse vehicle of FIG. 6 including a movable partition to direct refuse into different refuse compartments, according to an exemplary embodiment;

FIG. 10 is a flow diagram of a process for detecting and sorting refuse, according to an exemplary embodiment;

FIG. 11 is a diagram of a side loading refuse vehicle including multiple refuse compartments and an object detection and sorting system, according to an exemplary embodiment;

FIG. 12 is a diagram of a side loading refuse vehicle including a single refuse compartment and the object detection and sorting system of FIG. 11, according to an exemplary embodiment;

FIG. 13 is a diagram of a front end loading refuse vehicle including an intermediate refuse container with a side loading apparatus and the object detection and sorting system of FIG. 11, according to an exemplary embodiment;

FIG. 14 is a diagram of a hopper of a multi-compartment refuse vehicle for allowing or limiting access to one of multiple refuse compartments, according to an exemplary embodiment;

FIG. 15 is a diagram of a side loading refuse vehicle including the object detection and sorting system of FIG. 11 and parts of the refuse detection and sorting system of FIG. 6, according to an exemplary embodiment;

FIG. 16 is a diagram of image data obtained from a camera of the object detection and sorting system of FIG. 11, according to an exemplary embodiment;

FIG. 17 is a diagram of a robotic arm implement of the object detection and sorting system of FIG. 11, according to an exemplary embodiment;

FIG. 18 is a diagram of a customer refuse container including a camera, according to an exemplary embodiment;

FIG. 19 is a diagram of the customer refuse container of FIG. 18, according to an exemplary embodiment;

FIG. 20 is a block diagram of the object detection and sorting system of FIG. 11, according to an exemplary embodiment;

FIG. 21 is a flow diagram of a process for detecting objects and quarantining the objects from refuse on a refuse vehicle, according to an exemplary embodiment;

FIG. 22 is a flow diagram of a process for detecting objects and tracking objects in a refuse compartment of a refuse vehicle, according to an exemplary embodiment;

FIG. 23 is a diagram of a remote computing system that communicates with a fleet of refuse vehicles via telematics units, according to an exemplary embodiment;

FIG. 24 is a block diagram of the remote computing system of FIG. 23, according to an exemplary embodiment;

FIG. 25 is a flow diagram of a process for determining customer refuse profiles and generating a route based on the profiles, according to an exemplary embodiment;

FIG. 26 is a block diagram of a control system of a refuse vehicle or delivery vehicle that can be controlled adaptively based on current payload, according to an exemplary embodiment;

FIG. 27 is a block diagram of a controller of the control system of FIG. 26, according to an exemplary embodiment;

FIG. 28 is a flow diagram of a process for adaptively controlling a refuse vehicle based on a payload of the refuse vehicle, according to an exemplary embodiment;

FIG. 29 is a block diagram of a remote computing system in communication with a refuse vehicle and refuse containers along a route for route planning, according to an exemplary embodiment;

FIG. 30 is a diagram illustrating a refuse vehicle with a heads up display on the windshield for providing route instructions, according to an exemplary embodiment;

FIG. 31 is a diagram illustrating a remote computing system in communication with multiple refuse containers in a mesh network, according to an exemplary embodiment;

FIG. 32 is a side view of a refuse container including sensors for detecting refuse in the refuse container and a wireless transceiver, according to an exemplary embodiment;

FIG. 33 is a flow diagram of a process for route planning based on data obtained from multiple refuse containers, according to an exemplary embodiment; and

FIG. 34 is a flow diagram of a process for preconditioning a refuse vehicle and performing system checks in advance of a scheduled deployment time, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle can be configured to report its status (e.g., location, fill level, etc.) to a remote or cloud computing system. The remote or cloud computing system can also be configured to obtain data from multiple refuse containers in a geographic area. The remote computing system may determine a route for the refuse vehicle based on the status of the refuse vehicle and the data obtained from the multiple refuse containers. The remote computing system is configured to build profiles by obtaining historical data for each customer or geographic area and may use the profiles to generate or determine the route for the refuse vehicle in combination with the status of the refuse vehicle and the data obtained from the refuse containers.

### Refuse Vehicle

### Front-Loading Configuration

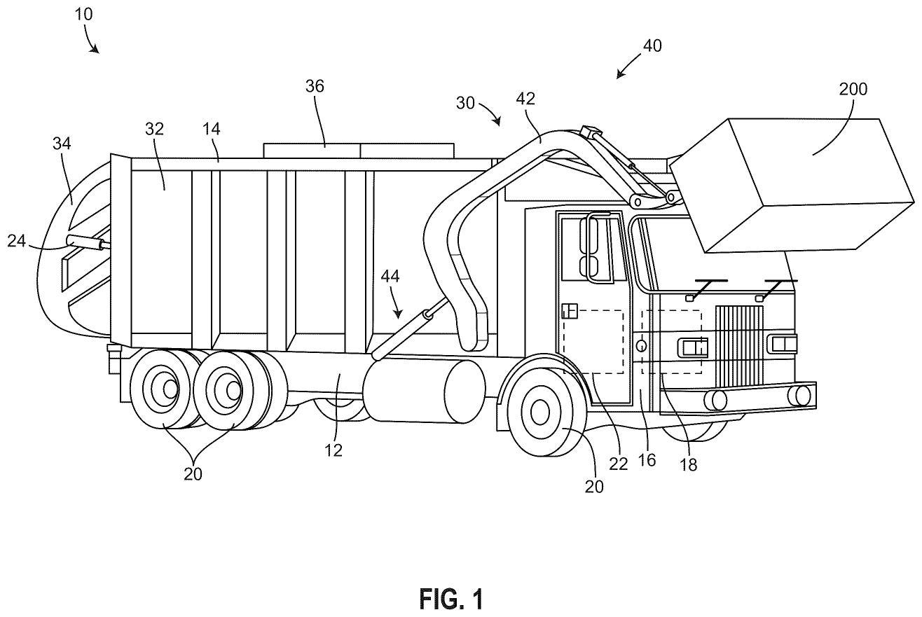

Referring to FIG. 1, a vehicle, shown as refuse vehicle 10 (e.g., a garbage truck, a waste collection truck, a sanitation truck, etc.), is shown that is configured to collect and store refuse along a collection route. In other embodiments, the refuse vehicle 10 is another type of vehicle such as a response vehicle, a police vehicle, an ambulance, a Department of Transportation vehicle, a roadside assistance vehicle, a fire truck, a refuse truck, a plow truck, a construction vehicle, a street sweeper, a meter-maid vehicle, and/or still another type of vehicle. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment as described in greater detail in U.S. application Ser. No. 17/558,183, filed Dec. 12, 2021, the entire disclosure of which is incorporated by reference herein.

### Rear-Loading Configuration

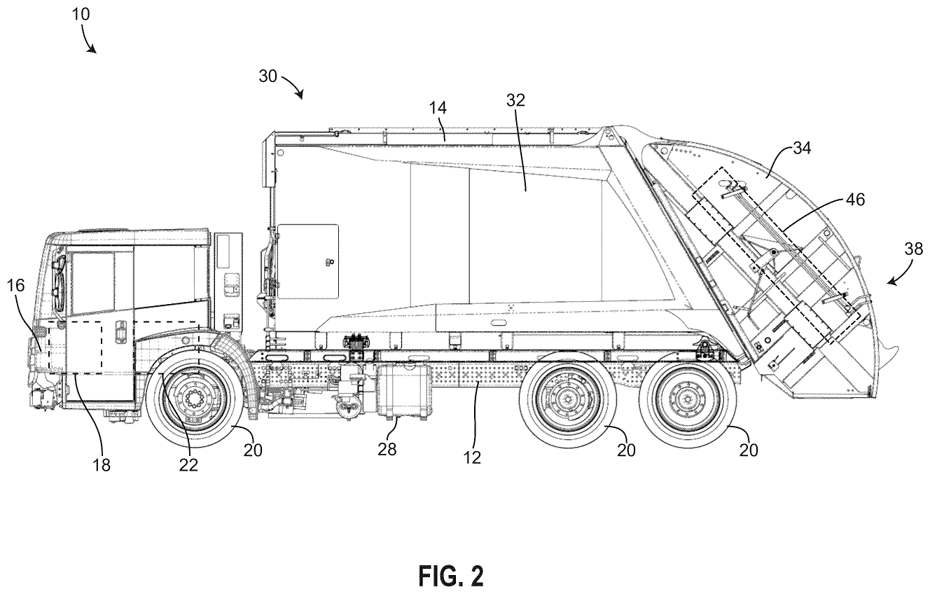

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

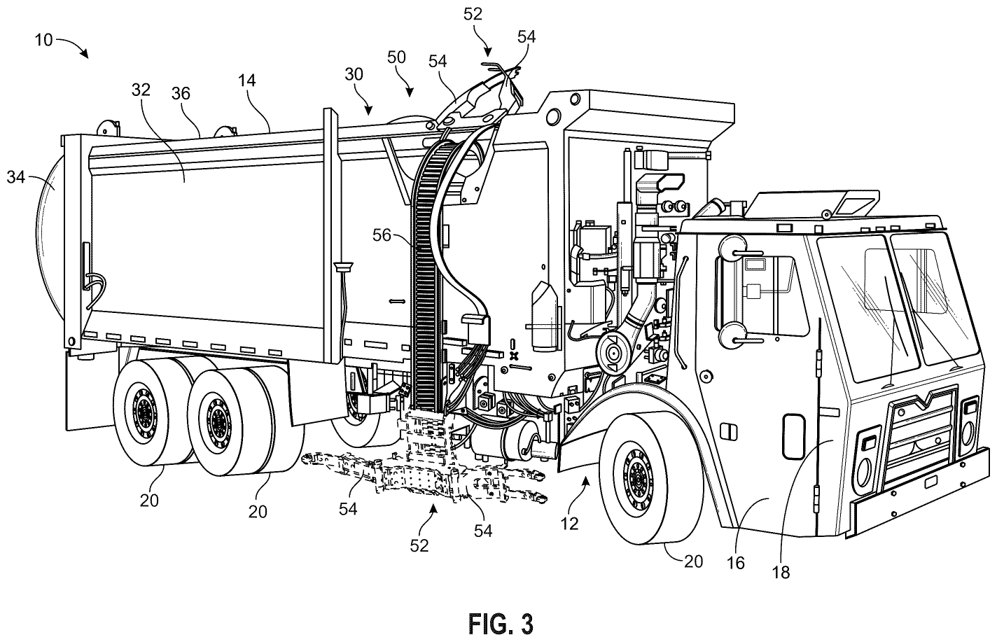

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

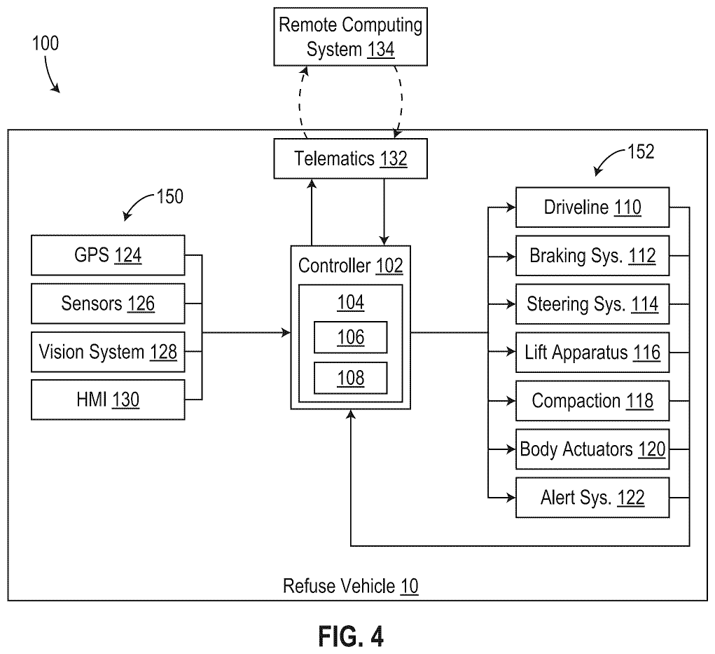

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

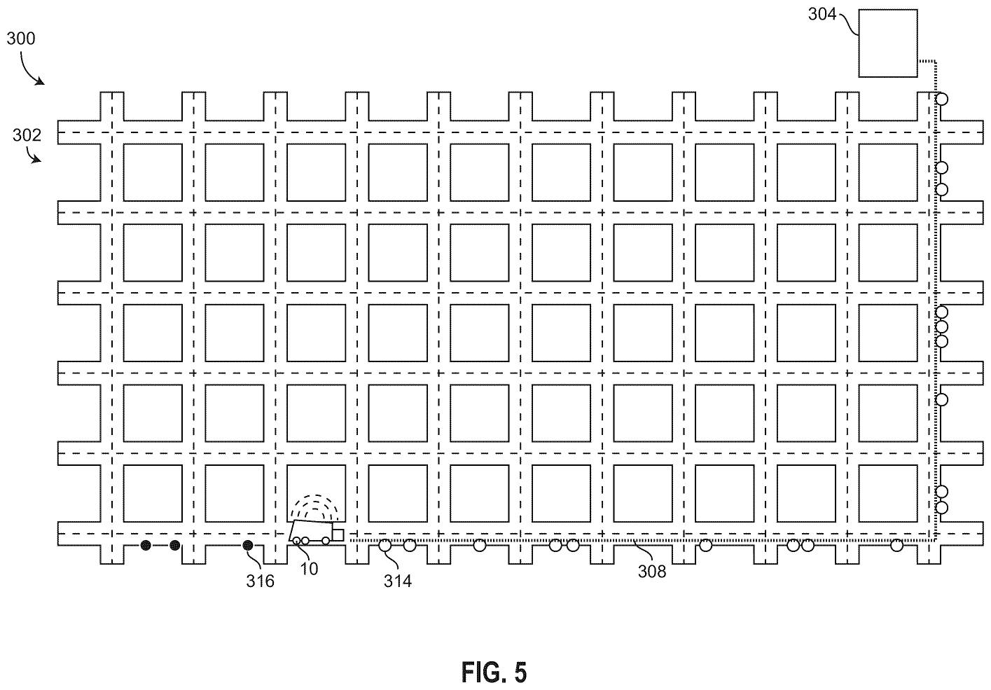

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Refuse Stream Sorting System

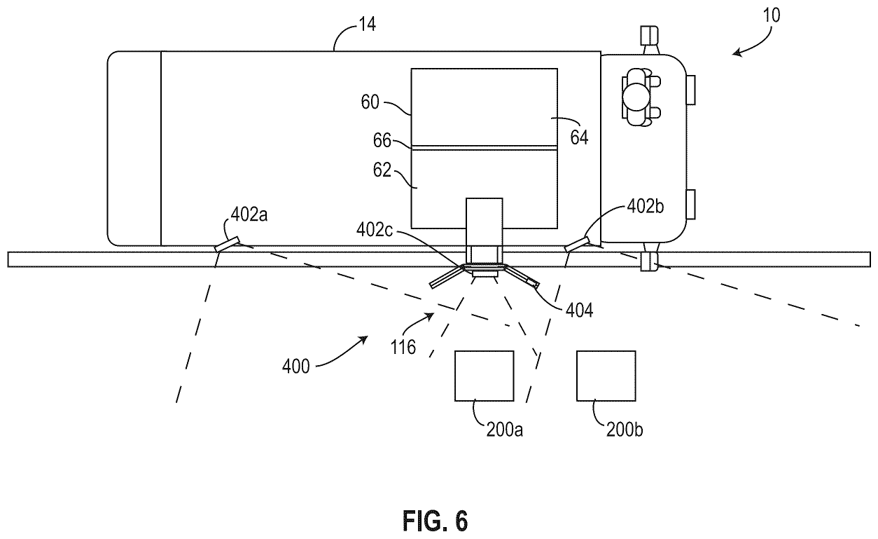

Referring to FIGS. 6-10, the refuse vehicle 10 may be equipped with a stream sorting system 400 that is configured to identify a type of refuse within a waste receptacle (e.g., the refuse container 200) and ensure that the refuse is emptied into an appropriate chamber or collected by a refuse vehicle that is configured to collect that type of refuse. The stream sorting system 400 facilitates sorting garbage from recycling or maintaining segregation of different types of refuse.

Referring particularly to FIG. 6, the stream sorting system 400 may be provided on a side-loading refuse vehicle 10. The refuse vehicle 10 includes the lift apparatus 116 on a curbside of the refuse vehicle 10. The lift apparatus 116 may have the form of a robotic arm having multiple articulable joints and a claw or grabber, a tracked lift apparatus including a grabber, or any combination thereof. The stream sorting system 400 can include multiple cameras, shown as first camera 402a, second camera 402b, and third camera 402c. While the cameras 402 are shown disposed on a curb-side of the refuse vehicle 10, the cameras 402 may be positioned on a front of the refuse vehicle 10, a rear, on different corners, at different heights, at different orientations, on a street-side of the refuse vehicle 10, etc. More generally, the cameras 402 are directed outwards such that refuse containers 200 (e.g., first refuse container 200a and second refuse container 200b) are within a field of view of the cameras 402. The cameras 402 may obtain image data of the refuse containers 200 as the refuse vehicle 10 arrives at the refuse containers 200. As shown in FIG. 6, the third camera 402c may be disposed on a claw or portion of the lift apparatus 116.

The refuse vehicle 10 may be a multi-chambered vehicle including at least two refuse compartments, each for a different type of refuse, or may be a single-chambered vehicle including a single refuse compartment for one type of refuse. For example, the refuse vehicle 10 may be a garbage truck or a recycling truck with a single corresponding refuse compartment for garbage or recycling. The refuse vehicle 10 can also be a combination of a garbage truck and a recycling truck so that the refuse vehicle 10 can collect both garbage and recycling. If the refuse vehicle 10 is configured to collect both garbage and recycling (e.g., different types of refuse), the refuse vehicle 10 may include a hopper 60 having two hopper openings for the different types of refuse, shown in FIG. 6 as first hopper opening 62 and second hopper opening 64. Refuse of a first type (e.g., garbage) may be emptied into the first hopper opening 62 and refuse of a second type (e.g., recycling) may be emptied into the second hopper opening 64. The lift apparatus 116 may be configured to selectively transport and empty the refuse containers 200 into one of the first hopper opening 62 or the second hopper opening 64. In some embodiments, the hopper 60 has a partition 66 that is transitionable between different positions or states in order to allow access to one of the first hopper opening 62 or the second hopper opening 64, and to limit access to another of the first hopper opening 62 or the second hopper opening 64. In this way, the lift apparatus 116 and the hopper 60 may be operated to empty refuse into one of a first refuse compartment or a second refuse compartment.

The stream sorting system 400 can also include a radio frequency identification (RFID) detector 404 (e.g., an RFID reader, an RFID transponder, etc.) that is configured to wirelessly transmit energy to proximate RFID tags. The RFID detector 404 may monitor responses that are received from nearby RFID tags. In particular, the refuse containers 200 may include RFID tags that are configured to provide a response signal to the RFID detector 404. The RFID detector 404 may be positioned on the lift apparatus 116 or on an exterior surface of the refuse vehicle 10 such that the RFID detector 404 is sufficiently close to the refuse containers 200 to communicate with RFID tags. The stream sorting system 400 may also include separate QR code scanners or barcode scanners positioned on the lift apparatus 116 (e.g., on the grabber assembly 52) or on a side of the refuse vehicle 10.

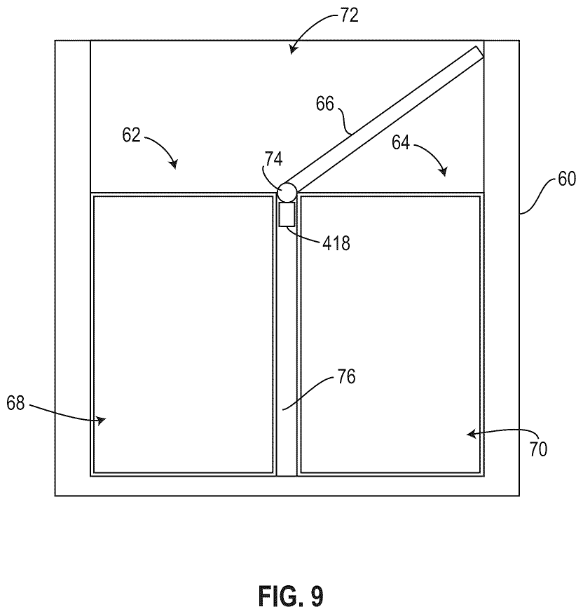

Referring particularly to FIG. 9, the hopper 60 is shown to include the first hopper opening 62 and the second hopper opening 64. The hopper 60 includes an overall hopper opening 72 through which refuse may be emptied into the first hopper opening 62 or the second hopper opening 64. The hopper 60 also includes a wall 76 that defines a boundary between the first hopper opening 62 and the second hopper opening 64. The first hopper opening 62 provides access to a first compartment 68 within the body 14 of the refuse vehicle 10, while the second hopper opening 64 provides access to a second compartment 70 within the body 14 of the refuse vehicle 10. The first compartment 68 may be a garbage compartment for the collection and transportation of garbage while the second compartment 70 may be a recycling compartment for the collection and transportation of recyclable materials. The hopper 60 also includes the partition 66 (e.g., a divider, a panel, a movable member, etc.) that is repositionable between a first position as shown and a second position. When the partition 66 is in the first position as shown, the second hopper opening 64 is limited from access while the first hopper opening 62 is accessible from the overall hopper opening 72. Similarly, when the partition 66 is in the second position, the first hopper opening 62 is limited from access while the second hopper opening 64 is accessible from the overall hopper opening 72. The partition 66 is shown pivotally coupled with a pivot point 74 at a top of the wall 76 and operably coupled with an actuator 418 (e.g., a partition actuator) such as an electric motor, a hydraulic cylinder, etc. The pivotal coupling and rotation of the partition 66 as shown and described herein with reference to FIG. 9 is illustrative only and should not be understood as limiting. For example, the partition 66 may be formed by a pair of trap doors that each limit or allow access to a corresponding one of the first hopper opening 62 or the second hopper opening 64 and are independently operable to transition between an open state or a closed state. In some embodiments, the operability of the partition 66 between a first position and a second position or a first orientation and a second orientation is optional if the lift apparatus 116 is capable of operating to empty contents of the refuse containers 200 into the first hopper opening 62 or the second hopper opening 64.

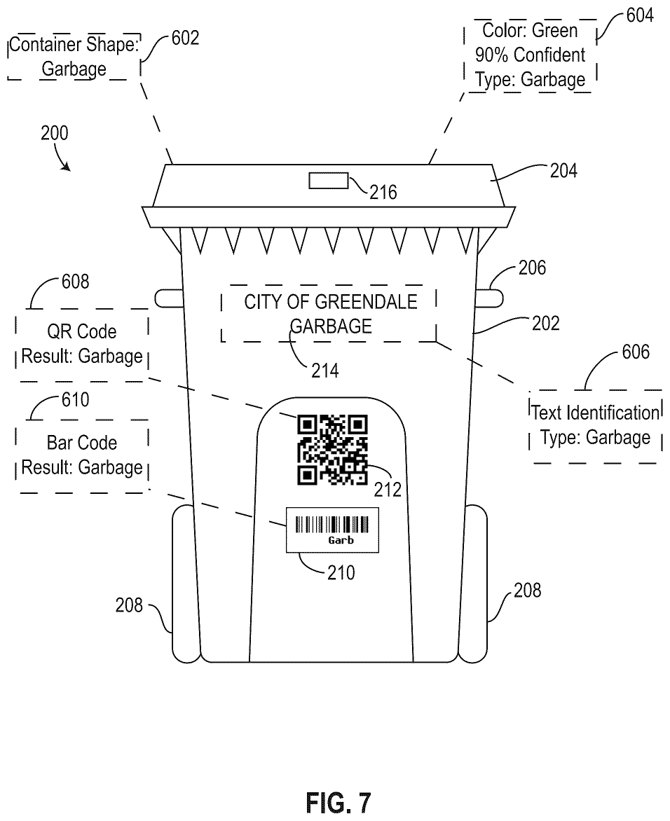

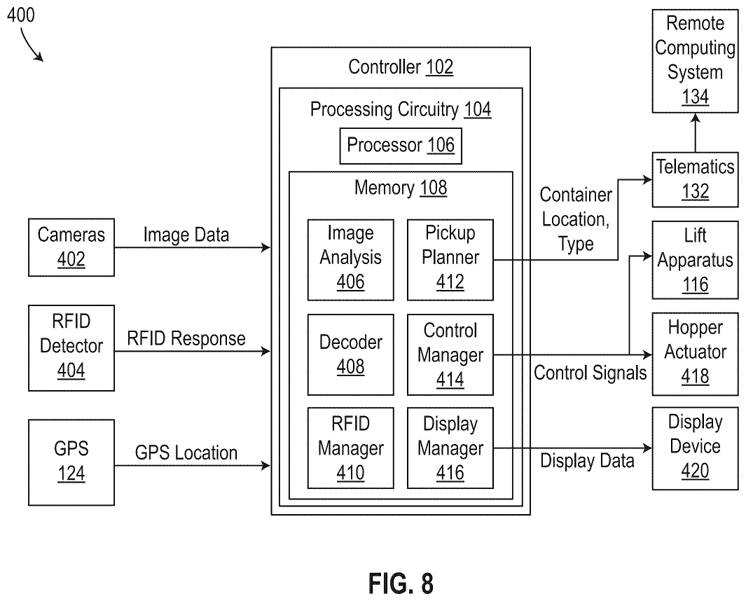

Referring to FIGS. 7 and 8, the controller 102 may be configured to implement various control and display functionality of the stream sorting system 400. The stream sorting system 400 includes the cameras 402, the RFID detector 404, the GPS system 124, the controller 102, the telematics 132, the lift apparatus 116, the hopper actuator 418, and a display device 420, according to some embodiments. As shown in FIG. 7, a given refuse container 200 can include a body 202 that defines a compartment or inner volume for refuse, a pair of wheels 208, handles 206, a lid 204, and printed text 214 or decals. The refuse container 200 may also include an RFID tag 216. The refuse container 200 may also include a quick response (QR) code 212. The refuse container 200 may also include a barcode 210. In some embodiments, one or more portions of the refuse container 200 have different colors to indicate whether the refuse container 200 contains garbage or recyclable materials.

As shown in FIG. 8, the memory 108 of the controller 102 includes image analysis 406, a decoder 408, an RFID manager 410, a pickup planner 412, a control manager 414, and a display manager 416. The image analysis 406 may obtain the image data from the cameras 402 of the refuse containers 200 that are within the field of view of the cameras 402. The image analysis 406 implemented by the processing circuitry 104 of the controller 102 is performed in order to identify a feature of the refuse container 200 in order to predict or identify a type of refuse that is within the refuse container 200 (e.g., whether the refuse container 200 is a recycling container or a garbage can). The image analysis 406 may include identifying a color of the refuse container 200 or one or more portions of the container 200 (e.g., a color of the lid 204, a color of the body 202, etc.), and identifying, based on the detected color of the refuse container 200, the type of refuse that is within the refuse container 200. The image analysis 406 may also be configured to predict the type of refuse within the refuse container 200 based on a shape or size of the refuse container 200. For example, if standard refuse containers are used with different sizes and shapes for recycling as opposed to garbage, the image analysis 406 can be implemented in order to identify, based on the size and shape, whether the refuse container 200 is a recycling container or a garbage can. The image analysis 406 may use the size, shape, and position of features such as the body 202, the handles 206, the lid 204, the wheels 208, etc., alone or in combination with each other.

The image analysis 406 may also identify the text 214 on the refuse container 200. For example, the text 214 on the refuse container may indicate whether the refuse container 200 is a garbage can or a recycling can. The image analysis 406 may perform an optical character recognition (OCR) technique and use a database of terms to identify, based on the text 214, whether the refuse container 200 is a recycling container or a garbage can (e.g., to predict the type of refuse that is within the refuse container 200).

The image analysis 406 may be configured to implement any machine learning, neural network, or artificial intelligence in order to identify whether the refuse container 200 is a garbage can or a recycling container (e.g., to predict a type of refuse within the refuse container 200). For example, the controller 102 may implement the image analysis 406 by performing any of the functionality as described in greater detail in U.S. application Ser. No. 16/758,834, filed Apr. 23, 2020, the entire disclosure of which is incorporated by reference herein. The image analysis 406 may be implemented locally on the controller 102 or remotely by the remote computing system 134. The controller 102, or more generally, the stream sorting system 400, may also be configured to perform any of the functions or techniques to identify the type of refuse in the refuse container 200 or identify the type of refuse container 200 as described in greater detail in U.S. application Ser. No. 17/189,740, filed Mar. 2, 2021, the entire disclosure of which is incorporated by reference herein.

The decoder 408 can also be configured to obtain the image data from the cameras 402 and identify QR codes or bar codes in the image data of the refuse container 200. The decoder 408 may implement a QR code or barcode decoding technique based on the image data of the QR code 212 or the barcode 210 to determine results. The results may indicate a type of refuse container 200 that is present in the image data (e.g., a garbage can or a recycling bin).

The RFID manager 410 is configured to receive the RFID response from the RFID scanner 404 obtained from the RFID tag 216 of the refuse container 200. The RFID manager 410 may analyze the RFID response to determine, based on the RFID response, the type of refuse that should be present in the refuse container 200.

The image analysis 406, the decoder 408, and the RFID manager 410 may be configured to determine, using the above described functionality, a predicted type of refuse that is present in the refuse container 200 and provide their results to the pickup planner 412, the control manager 414, and the display manager 416. The pickup planner 412 may determine, based on the type of refuse in the refuse container 200 and abilities of the refuse vehicle 10 (e.g., the type of refuse that the refuse vehicle 10 is capable of collecting, whether the refuse vehicle 10 has multiple refuse compartments, a fill level of refuse in the refuse compartments, etc.), if the refuse vehicle 10 is capable of emptying the refuse of the refuse container 200 into the hopper 60. If the refuse vehicle 10 is not capable of emptying the refuse of the refuse container 200, the pickup planner 412 may use the GPS location as the container location, and the type of refuse in the refuse container to schedule a pickup by a subsequent refuse vehicle. The pickup planner 412 can provide the container location and the type of refuse in the refuse container 200 to the remote computing system 134 for scheduled pickup at a later time via the telematics 132.

The control manager 414 is configured to use the results of any of the image analysis 406, the decoder 408, or the RFID manager 410 to operate at least one of the lift apparatus 116 or the hopper actuator 418 to empty the contents of the refuse container 200 into the hopper 60 of the refuse vehicle 10. For example, if the refuse vehicle 10 is a single compartment refuse vehicle that is configured to collect the type of refuse that is within the refuse container 200, the control manager 414 may provide control signals to the lift apparatus 116 to grasp, lift, and empty the refuse of the refuse container 200 into the hopper 60. Similarly, if the refuse vehicle 10 is a multi-compartment refuse vehicle, that control manager 414 may operate the hopper actuator 418 to transition the partition 66 into a desired state and operate the lift apparatus 116 to empty contents of the refuse container 200 into the corresponding type of refuse compartment of the refuse vehicle 10 (e.g., the garbage compartment if the type of refuse in the refuse container 200 is garbage or the recycling compartment if the type of refuse in the refuse container 200 is recycling). In some embodiments, the control manager 414 is configured to operate the lift apparatus 116 without operating the hopper actuator 418 to empty the contents of the refuse container 200 into the appropriate hopper opening of the hopper 60 based on the type of refuse in the refuse container 200.

Referring to FIGS. 7 and 8, the display manager 416 may be configured to generate display data and operate the display device 420 to provide the display data to an operator of the refuse vehicle 10 or a user that remotely controls or monitors the refuse vehicle 10. The display data may include various callouts overlaid or superimposed onto a real-world or digital image of the refuse container 200. The callouts may indicate the results of the image analysis 406 and can include lines indicating the corresponding features. For example, as shown in FIG. 7, the display data may include a first callout 602 or visual indication that indicates the results of a container shape (e.g., container shape: garbage). The display data may also include a second callout 604 or visual indication that indicates the results of image analysis of particular features (e.g., color of a particular feature or component such as the lid 204, confidence of results, corresponding type). The display data may also include a third callout 606 that indicates the results of text identification (e.g., OCR of the detected text 214 of the refuse container 200). The display data may also include a fourth callout 608 that indicates the results of QR decoding (e.g., QR code result: garbage). The display data may also include a fifth callout 610 that indicates the results of barcode decoding (e.g., bar code result: garbage).

It should be understood that while FIGS. 6-10 as described herein refer to only two types of refuse (i.e., garbage and recycling), the stream sorting system 400 may be configured to identify any number of types of refuse or refuse containers using the techniques described herein. For example, if different municipalities have separate containers for cardboard recycling as opposed to glass recycling, in addition to having garbage cans, the stream sorting system 400 may be configured to determine which of the three different types of refuse are likely present in the refuse containers 200.

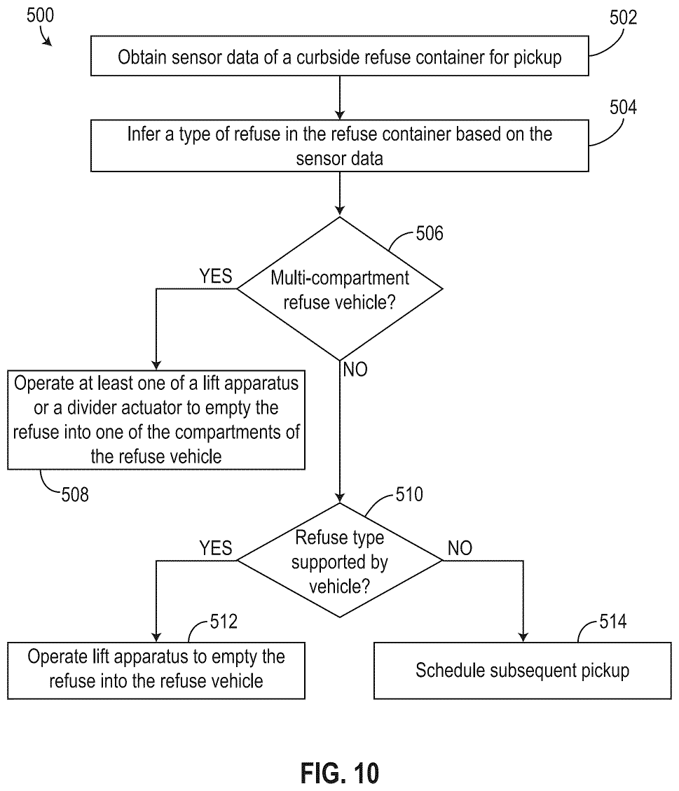

Referring to FIG. 10, a flow diagram of a process 500 for sorting refuse from different refuse containers includes steps 502-514, according to some embodiments. The process 500 may be performed by the stream sorting system 400 of the refuse vehicle 10. The process 500 advantageously facilitates keeping different types of refuse separate as desired. For example, refuse vehicles may autonomously transport along routes and collect garbage and recycling. The refuse vehicles may be equipped with detection sensors in order to infer, based on the feedback from the detection sensors, which of multiple types of refuse are present in the refuse containers. Advantageously, the process 500 facilitates fully autonomous or semi-autonomous waste collection without requiring an operator of the vehicle to manually exit the vehicle and check or move refuse containers.

The process 500 includes obtaining sensor data of a curbside refuse container for pickup (step 502), according to some embodiments. The refuse container may be position on a curb, in front of a refuse vehicle, behind a refuse vehicle, etc. The sensor data may include image data or a reply signal from an RFID tag of the refuse container. The sensor data can be obtained from sensors that are disposed on an exterior of the refuse vehicle. For example, the refuse vehicle can include cameras positioned about a body or cabin of the refuse vehicle that have a field of view pointing outwards from the refuse vehicle towards a location where refuse containers are expected to be located for pickup. Step 502 can be performed by the controller 102 or any other processing unit of the stream sorting system 400 by receiving image data from the cameras 402, RFID responses from the RFID detector 404, etc.

The process 500 includes inferring a type of refuse in the refuse container based on the sensor data (step 504), according to some embodiments. Step 504 can include performing an image analysis or image recognition technique based on features, colors, sizes, shapes, etc., of the refuse container in the image data. Step 504 can also include performing decoding techniques to decode the information contained in a QR cod or a barcode. Step 504 can also include analyzing a response from an RFID tag of the refuse container. Step 504 may be performed by the controller 102 by implementing at least one of the image analysis 406, the decoder 408, or the RFID manager 410.

The process 500 includes identifying if the refuse vehicle is a multi-compartment refuse vehicle (step 506), according to some embodiments. Step 506 may be performed based on known characteristics of the refuse vehicle. Step 506 can be performed by the controller 102. If the refuse vehicle is a multi-compartment refuse vehicle (step 506, “YES”), process 500 may proceed to step 508. If the refuse vehicle is not a multi-compartment refuse vehicle (step 506, “NO”), process 500 proceeds to step 510.

The process 500 includes operating at least one of a lift apparatus or a divider actuator to empty the refuse of the refuse container into one of the compartments of the refuse vehicle (step 508), according to some embodiments. Step 508 may include operating the lift apparatus 116 (e.g., a robotic arm, a side loading arm of a refuse vehicle, etc.) and the actuator 418 in order to empty the contents of the refuse container into one of the first compartment 68 or the second compartment 70 through the hopper 60. Step 508 may include operating the lift apparatus 116 to empty contents of the refuse container into a hopper opening corresponding to the desired compartment without requiring operation of the divider actuator if the lift apparatus 116 is operably capable of lifting the refuse container to different locations of the hopper. Step 508 can be performed by the controller 102 by generating and providing controls to the lift apparatus 116 and the actuator 418. Step 508 may be performed if the refuse vehicle is a multi-compartment refuse vehicle and has sufficient storage space in a target compartment for the contents of the refuse container.

The process 500 includes identifying if the type of refuse inferred at step 504 is supported by the refuse vehicle (step 510) if the refuse vehicle is not a multi-compartment refuse vehicle (step 506, “NO”), according to some embodiments. Step 510 may include using stored data regarding whether the refuse vehicle is intended to collect garbage or recycling or whether the refuse vehicle is currently collecting garbage, recycling, or a different type of refuse. Step 510 can be performed by the controller 102 based on known characteristics or current route of the refuse vehicle. Step 510 can include comparing the type of refuse that the refuse vehicle is intended to collect to the type of refuse that is inferred to be present within the refuse container. If the type of refuse that the refuse vehicle is intended to collect matches the type of refuse that is inferred to be present in the refuse container (step 510, “YES”), process 500 proceeds to step 512. If the type of refuse that the refuse vehicle is intended to collect does not match the type of refuse that is inferred to be present in the refuse container (e.g., the refuse vehicle is a garbage truck and the refuse container is a recycling bin) (step 510, “NO”), process 500 proceeds to step 514.

The process 500 includes operating the lift apparatus to empty the refuse into the refuse vehicle (step 512) in response to determining that the type of refuse inferred to be present in the refuse container matches or is supported by the refuse vehicle (step 510, “YES”), according to some embodiments. Step 512 can be performed by the controller 102 by operating the lift apparatus 116 to lift and empty contents of the refuse container into a hopper of the refuse vehicle 10.

The process 500 includes scheduling subsequent pickup of the refuse container (step 514) if the type of refuse inferred to be present in the refuse container does not match or is not supported by the refuse vehicle (step 510, “NO”), according to some embodiments. Step 510 can be performed by the controller 102 (e.g., by the pickup planner 412) by providing type of the container (e.g., type of the refuse inferred to be present in the refuse container) and a location (e.g., a GPS location) of the container to a remote computing system (e.g., a fleet management system, a route planning system, etc.) such as the remote computing system 134. The remote computing system can use the indication of the type of the container or refuse and the location to schedule pickup by an appropriate refuse vehicle. For example, if the refuse vehicle is a recycling truck and infers that the refuse container is a garbage can, the remote computing system may schedule and dispatch collection of the contents of the garbage can based on the type of the container and the location provided by the controller 102.

### Contaminant Object or Material Detection and Sorting

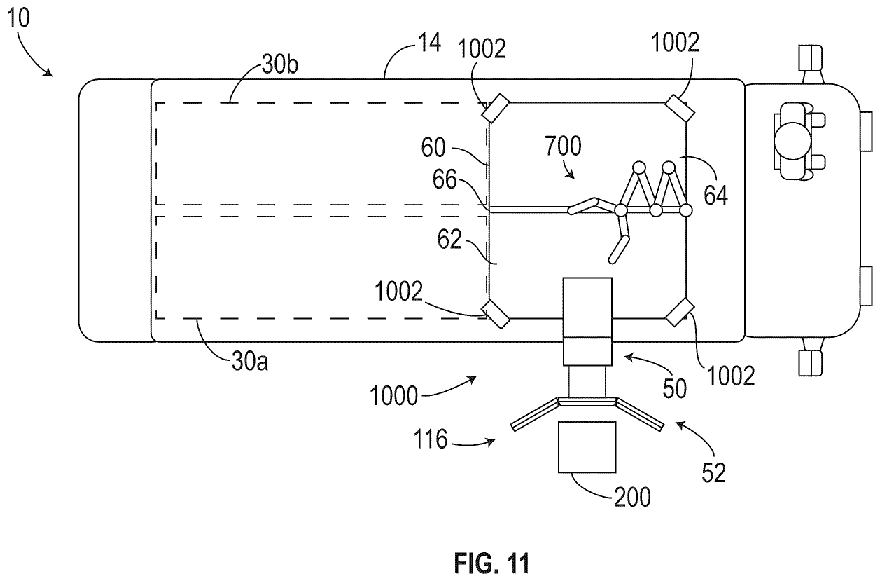

Referring to FIGS. 11-21, the vehicle 10 may include a material detection and sorting system 1000 that is configured to detect or identify one or more objects in refuse emptied from the refuse container 200 and sort the identified objects into a separate hopper or refuse compartment. The detection and sorting system 1000 includes one or more imaging devices, shown as cameras 1002 that are configured to obtain image data of refuse emptied into the hopper 60 of the refuse vehicle 10 or into an intermediate can that is emptied into the hopper 60 of the refuse vehicle (e.g., an intermediate can on a front loading refuse vehicle, a side loading refuse vehicle, or a rear loading refuse vehicle). The detection and sorting system 1000 is configured to detect different predetermined objects that have different disposal requirements (e.g., additional cost to dispose of the object) such as tires, rubber objects, televisions, washing machines or other appliances, large objects, branches, tree materials, garden materials, etc.

Referring particularly to FIG. 6, the refuse vehicle 10 includes the hopper 60 that includes two hopper openings, shown as hopper opening 62 which allows the ingress of refuse to a first refuse compartment 30a and hopper opening 64 which allows the ingress of refuse into a second refuse compartment 30b. The lift apparatus 116 may be configured to lift and empty contents of the refuse container 200 into the hopper opening 62 for regular refuse collection. The hopper 60 includes one or more of the cameras 1002 disposed about the hopper 60 and configured to obtain image data of refuse that is emptied into the hopper opening 62. The detection and sorting system 1000 also includes a robotic arm implement 700 that is configured to be operated responsive to detection based on the image data obtained by the cameras 1002. For example, the robotic arm implement 700 may include multiple boom segments or armatures that are pivotally coupled at their ends with each other and are configured to be driven to rotate relative to each other to lift or move objects detected in the image data. The robotic arm implement 700 also includes a grabber assembly (e.g., a claw having articulable fingers) disposed at an end of the boom segments that is configured to grasp objects detected in the hopper opening 62.

The hopper opening 62 may feed into the first refuse compartment 30a such that refuse emptied into the first hopper opening 62 is directed to the first refuse compartment 30a, while the hopper opening 64 feeds into the second refuse compartment 30b that is separate from the first refuse compartment such that refuse emptied into the second hopper opening 64 feeds into the second refuse compartment 30b. The robotic arm implement 700 is configured to be operated to grasp an object (e.g., a television, an appliance, etc.), lift the object out of the hopper opening 62 and place the object in the hopper opening 64. The hopper opening 62 and the hopper opening 64 are defined by wall 76 that extends between the hopper opening 62 and the hopper opening 64. The robotic arm implement 700 is configured to move objects between either side of the wall 76, based on the image data of the cameras 1002, from the hopper opening 62 to the hopper opening 64 in order to separate certain types of objects from normal refuse. For example, the second refuse compartment 30b may be provided for hazardous materials or materials that should be kept separate from regular refuse, while the first refuse compartment 30a is provided for regular refuse. The first refuse compartment 30a and the second refuse compartment 30b may be the same size or may be different sizes (e.g., as shown in FIG. 8).

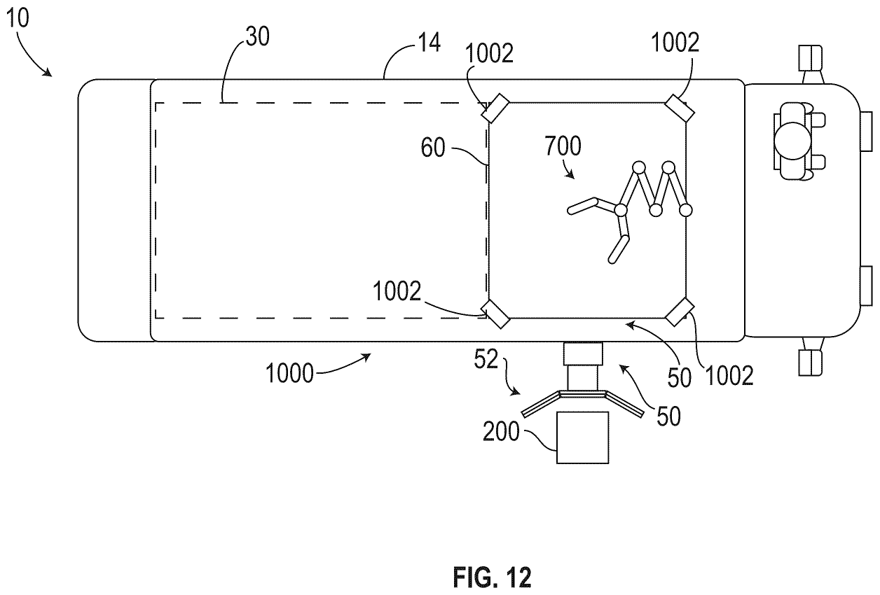

Referring to FIG. 12, the refuse vehicle 10 may be equipped with the robotic arm implement 700 without a divided body. The robotic arm implement 700 can be operated based on the image data obtained from the cameras 1002 to grasp and remove certain types of objects from the hopper 60. The robotic arm implement 700 can be operated to grasp, remove, and set the objects (e.g., appliances, tires, chemicals, oil containers, or other contaminants) back to the ground surface at which the refuse container 200 was obtained from. In particular, the robotic arm implement 700 may be configured to reject certain objects from the hopper 60 that should not be packed into the refuse compartment 30 and return them to the customer. In some embodiments, the refuse vehicle 10 includes the cameras 1002 without the robotic arm implement 700 such that the image data can be used to identify or predict a particular location of the refuse compartment 30 at which the object is present (e.g., which portion of the packed load of refuse in the refuse compartment 30 at which the object is present).

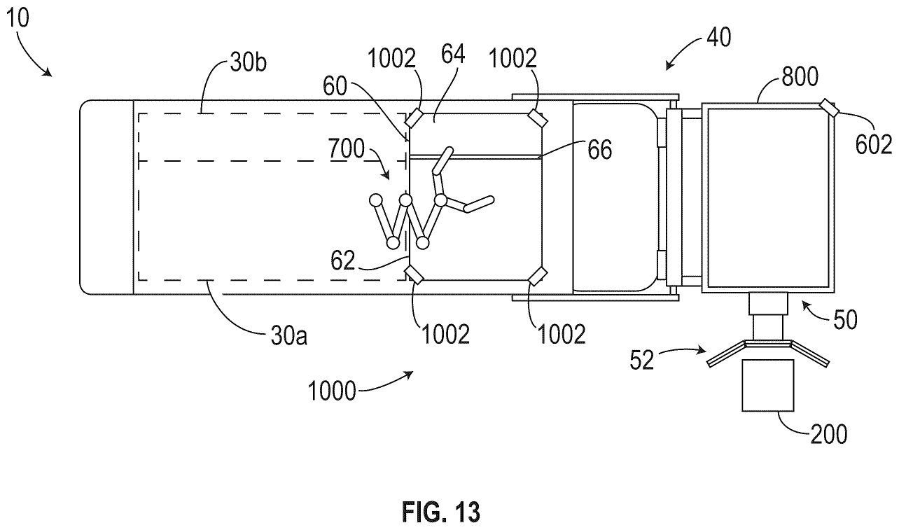

Referring to FIG. 13, the refuse vehicle 10 may be configured as a front loading refuse vehicle having an intermediate can, shown as intermediate container 800. The intermediate container 800 includes the grabber assembly 52 and the lift assembly 50 disposed on a side of the intermediate container 800 (e.g., on a curb-side of the intermediate container 800). The intermediate container 800 includes one of the cameras 1002 disposed on an edge and configured to obtain image data of contents of the intermediate container 800. The intermediate container 800 can also include the robotic arm implement 700 may be positioned on a side of the intermediate container 800 in order to remove detected objects from the intermediate container 800 or may be positioned proximate the hopper 60 in order to remove objects from the hopper 60 after the intermediate container 800 has been emptied into the hopper 60. As shown in FIG. 13, the first refuse compartment 30a may be larger than the second refuse compartment 30b. The front end loading refuse vehicle 10 shown in FIG. 13 with the intermediate container 800 may include equally sized first refuse compartment 30a and second refuse compartment 30b. If a particular object is detected in the intermediate container 800 by the camera(s) 602 of the intermediate container 800, the robotic arm implement 700 may be configured to locate the object based on the image data from the cameras 1002 of the hopper 60, grasp the object, and remove the object from the first hopper opening 62 and place the object in the second hopper opening 64 for storage in the second refuse compartment 30b.

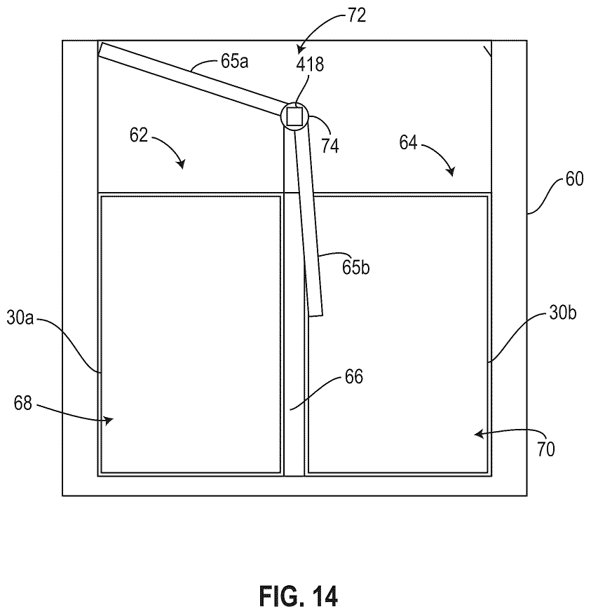

Referring to FIG. 14, the hopper may include a first arm 65a and a second arm 65b that are pivotally coupled at a single end with pivot point 74 at the top of partition 66. In some embodiments, the hopper 60 includes a pair of hopper actuators 418 that are each operably coupled with a corresponding one of the arms 65. Each of the arms 65 may be transitionable, by operation of the hopper actuators 418, into an open position and a closed position. As shown in FIG. 14, the first arm 65a is in the closed position such that refuse emptied into the hopper 60 through the overall hopper opening 72 is limited from being directed into the first hopper opening 62. On the other hand, the second arm 65b is shown in the open position such that refuse emptied into the overall hopper opening 72 is allowed to fall into the second hopper opening 64 such that the refuse can be directed into the second refuse compartment 30b through the second compartment opening 70. Each of the arms 65 may be transitionable between the open position and the closed position independently to direct refuse into either the first refuse compartment 30a or the second refuse compartment 30b. Similarly, the robotic arm implement 700 may be operated in coordination with the operation of the arms 65 such that detected objects are lifted out of one of the hopper openings 62 or 64 and moved into the other of the hopper openings 62 or 64 for stowage of the detected object in a particular compartment. If the refuse vehicle 10 is not equipped with the robotic arm implement 700, the arms 65 can be transitioned in order to direct an entire load of refuse that includes a detected hazardous material or specific object into one of the first refuse compartment 30a or the second refuse compartment 30b.

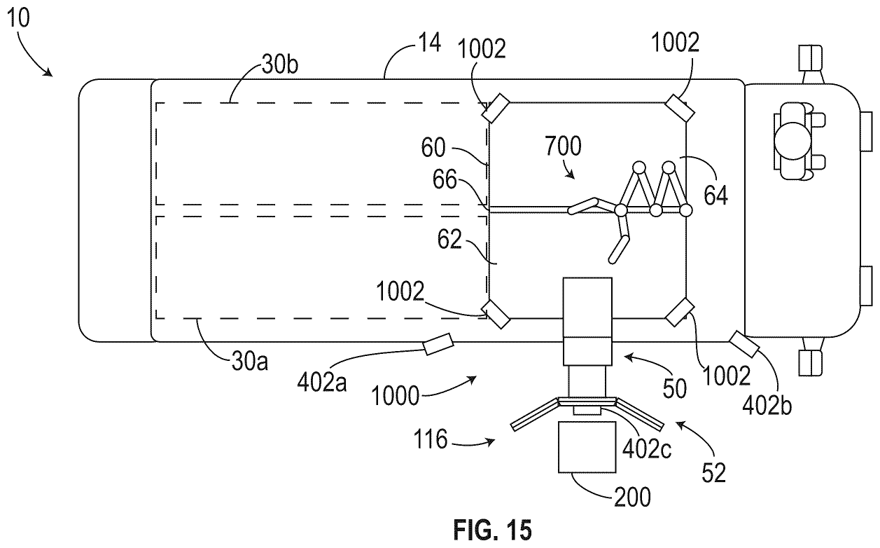

Referring to FIG. 15, the detection and sorting system 1000 can include the cameras 402 of the stream sorting system 400 in order to scan the refuse containers 200 and detect or infer the presence of a hazardous material in the refuse container 200. The image data obtained from the cameras 402 may be used by a controller of the detection and sorting system 1000 using an image recognition technique to detect or identify the presence of a particular type of object in the refuse containers 200. For example, if a washing machine, microwave, or freezer is protruding from a top of the refuse container 200 and is visible, the cameras 402 (e.g., the camera 402c) may obtain image data of the refuse container 200 and identify the presence of the washing machine, microwave, or freezer. The detection and sorting system 1000 may also include sensors or detectors configured to emit waves that can propagate through a side of the refuse container 200 in order to detect the presence of particular objects within the refuse container 200.

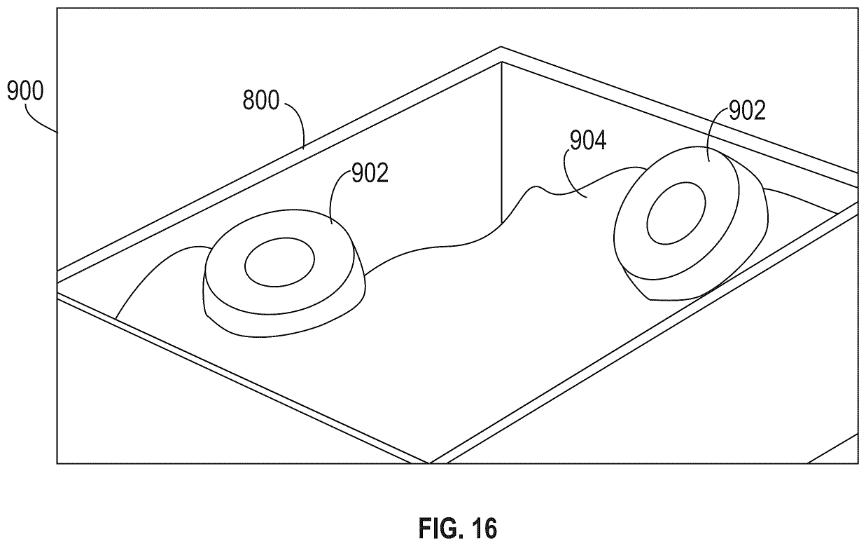

Referring to FIG. 16, a diagram illustrates image data 900 that may be obtained by the cameras 1002 on the intermediate container 800. The image data 900 includes a view of an interior of the intermediate container 800 illustrating refuse 904 and tires 902. Tires 902 may be one of the objects that can be detected and should be put into a different refuse compartment 30. The image data 900 can be used (e.g., analyzed) in order to detect the presence and location of the tires 902 in the intermediate container 800 such that the robotic arm implement 700 can be operated to grasp and remove the tires 902 once the contents of the intermediate container 800 are emptied into the hopper 60. Image data obtained from cameras 1002 of the hopper 60 may be similar to the image data 900 shown in FIG. 16 and can be used to operate the robotic arm implement 700 in order to grasp and move the tires 902 or other objects detected in the image data 900.

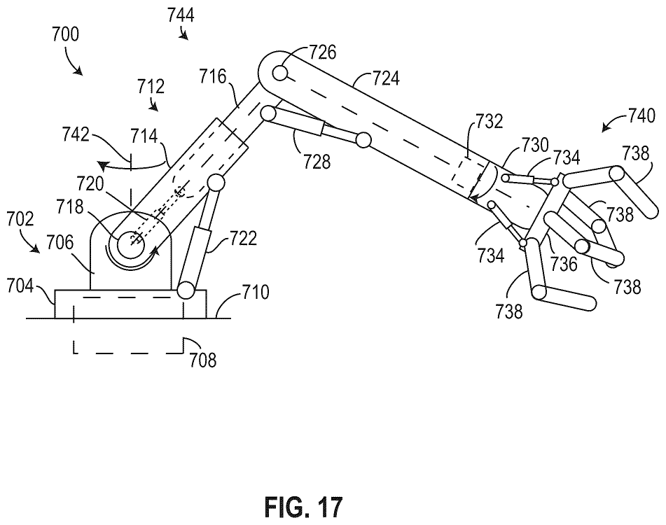

Referring to FIG. 17, the robotic arm implement 700 may include a base portion 702 that is pivotally coupled with a base surface 710 (e.g., a portion of the hopper 60) through a pivotal or rotatable coupler 704. The robotic arm implement 700 may include a rotary actuator 708 (e.g., an electric motor) configured to drive rotation of the robotic arm implement 700 about a corresponding axis 742 that extends through the rotatable coupler 704 in either direction. The base portion 702 also includes a pivotal coupling 706 defining a pivot point 718. The pivotal coupling 706 is fixedly coupled with the rotatable coupler 704. An arm assembly 744 is coupled with the base portion 702 at the pivot point 718. The arm assembly 744 is shown to include a first boom section 712 and a second boom section 724 but may include any number of boom sections as required in order to provide sufficient reach. The first boom section 712 may be a telescoping member including an outer member 714 that is pivotally coupled at a first end with the pivot point 718, and an inner member 716 that is received within the outer member 714 and can translate relative to the outer member 714 in order to extend or retract the first boom section 712. The robotic arm implement 700 may include a first actuator 722 that is coupled at a first end with the outer member 714 and at an opposite end with the rotatable coupler 704. The first actuator 722 is configured to extend or retract to drive the arm assembly 744 to rotate about the pivot point 718. The first boom section 712 may include an extension actuator 720 that is configured to extend or retract to drive the extension or retraction of the first boom section 712 (e.g., to drive the inner member 716 to translate relative to the outer member 714).

The second boom section 724 is pivotally coupled with an end of the inner member 716 at pivot point 726. The second boom section 724 may be driven to rotate about the pivot point 726 by extension or retraction of actuator 728. The second boom section 724 can be rotatably coupled with an end portion 730. The end portion 730 may be driven to rotate relative to the second boom section 724 about an axis extending lengthwise through the second boom section 724 by a rotary actuator 732. The rotary actuator 732 may be similar to the rotary actuator 708. The robotic arm implement 700 may also include a claw assembly 740 that is coupled with the second boom section 724. The claw assembly 740 may include a carriage 736 that is pivotally coupled with the end portion 730 and is configured to be driven to rotate (e.g., pivot, hinge, swivel, etc.) relative to the end portion 730 by actuators 734. The claw assembly 740 can include multiple fingers, shown as fingers 738 each including articulable sections pivotally coupled with each other and driven to articulate to grasp or release an object by operation of corresponding actuators.

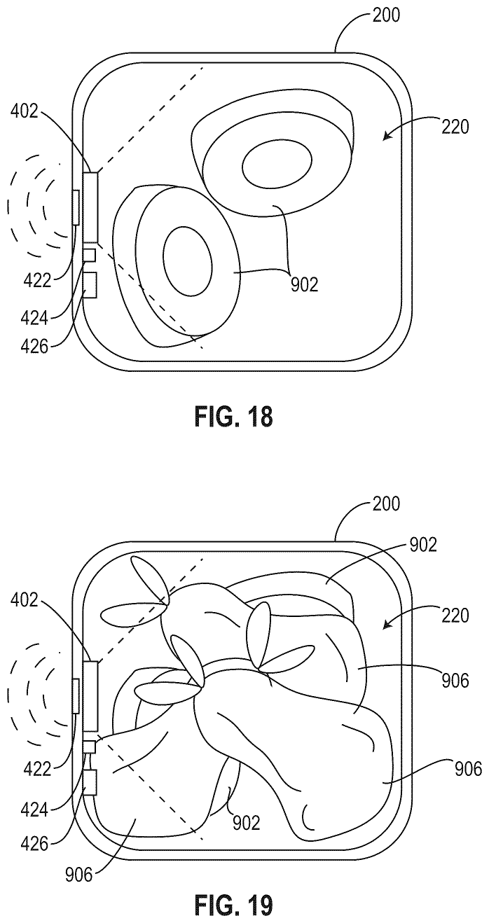

Referring to FIGS. 18 and 19, the refuse containers 200 may include cameras 402 configured to obtain image data of an inner volume 220 of the refuse containers 200. The cameras 402 can be positioned along an upper edge of the refuse containers 200 and may be directed downwards towards the inner volume 220 in order to obtain image data of the interior of the refuse container 200. The refuse containers 200 may include motion detectors 424 that are configured to detect motion and trigger activation of the camera 402 to obtain image data. In some embodiments, the camera 402 obtains image data periodically. The refuse containers 200 may include a power source 426 (e.g., a battery, a solar panel, etc.) configured to provide electrical power to the camera 402, the motion detector 424, and a control unit 422. The control unit 422 may include a wireless transceiver (e.g., a transponder, a radio, an RFID tag, a near field communications circuit, etc.) configured to receive power from the power source 426 and provide wireless signals including the image data obtained by the cameras 402.

The camera 402 of the refuse containers 200 can be configured to obtain image data as people place refuse into the refuse containers 200. For example, the individual or customer may place tires 902 at a bottom of the refuse container 200 and then cover the tires 902 (or other restricted objects such as cans of car oil, appliances, etc.) with garbage bags 906. The camera 402 may be configured to obtain image data of the tires 902 when the tires 902 or other restricted object are first placed in the refuse containers 200. The image data of the interior of the refuse container 200 that is obtained by the camera 402 may be stored in memory of a controller of the control unit 422 and transmitted (e.g., to a controller of the refuse vehicle 10, to the remote computing system 134, etc.) wirelessly via the wireless transceiver.

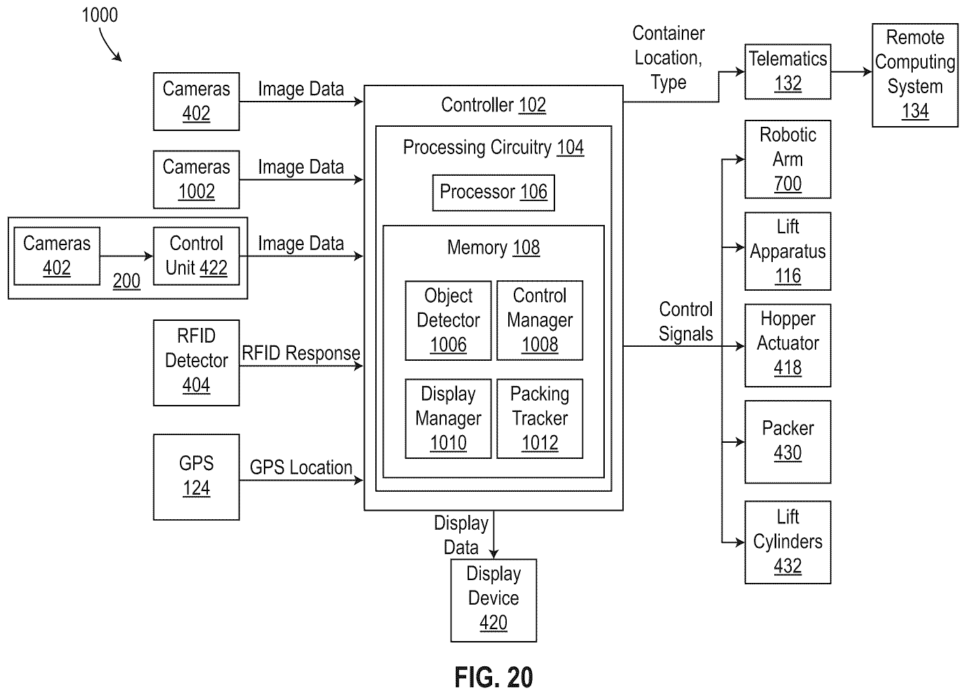

Referring to FIG. 20, the detection and sorting system 1000 includes the controller 102 that is configured to receive various inputs from data sources. In particular, the controller 102 may receive image data from the cameras 402 (e.g., externally facing cameras) and the cameras 1002 (e.g., cameras that obtain image data of the hopper 60 or the intermediate container 800). The controller 102 may also receive image data from the control unit 422 of the refuse container 200 as the refuse vehicle 10 pulls up to or approaches the refuse container 200. For example, the detection and sorting system 1000 may include an RFID detector (e.g., a transceiver) or any other wireless transceiver positioned on a grabber of the lift apparatus 116 (e.g., the grabber assembly 52) such that the wireless transceiver can receive data from the control unit 422. In some embodiments, the control unit 422 includes the camera 402 and is configured to receive wireless power from the RFID detector 404 or wireless transceiver of the detection and sorting system 1000 when the RFID detector 404 or wireless transceiver is proximate the control unit 422 at pickup. The control unit 422 may use the wirelessly transmitted power to respond with the image data stored in memory, or may use the wirelessly transmitted power to operate the camera 402 of the refuse container 200 to provide the image data. In this way, the control unit 422 and the camera 402 at the refuse container 200 may not necessarily require a power source and can use the wirelessly transmitted power in order to operate, or to operate if the power source at the refuse container 200 has failed.

The memory 108 of the controller 102 may include an object detector 1006, a control manager 1008, a display manager 1010, and a packing tracker 1012. The object detector 1006 may use similar techniques as the image analysis 406 described in greater detail above but in order to detect different types or classes of objects that should be separated from ordinary refuse. For example, the object detector 1006 may be implemented to perform similar image analysis or object detection techniques in order to detect chemicals, canisters, tanks, appliances, tires, oil cans, etc., or any other object that should be separated from regular refuse. The object detector 1006 is configured to provide results to the control manager 1008 or the display manager 1010.

The control manager 1008 is configured to use the results of the object detector 1006 to determine controls for the hopper actuator(s) 418, the lift apparatus 116 (e.g., the lift assemblies 50, the grabber assemblies 52, the lift assembly 40, etc.), and the robotic arm implement 700. The control manager 1008 may operate any of the hopper actuators 418, the lift apparatus 116, or the robotic arm implement(s) 700 as available on the refuse vehicle 10 to either move objects from one hopper opening 62 to another hopper opening 64 (e.g., from one side of the partition 66 to another side of the partition 66). For example, the control manager 1008 may operate the robotic arm implement 700 coordinated with operation of the hopper actuators 418 to lift a detected object from one side of the partition 66 to another side of the partition 66 for storage in a different refuse compartment 30. The control manager 1008 may also operate the robotic arm implement 700 to remove detected objects from the hopper 60 and place the objects back onto a ground surface in cases where the refuse vehicle 10 only includes a single refuse compartment 30, or if the refuse compartment 30 designated for that type of object is full. The control manager 1008 can be configured to use the results of the object detector 1006 to target the object within the hopper 60 or within the intermediate container 800 and operate the robotic arm implement 700 to grasp the object and move the object to a desired location (e.g., to a different hopper, back to the ground, etc.). In some implementations of the refuse vehicle 10, the refuse vehicle 10 does not include the robotic arm implement 700, and the entire contents of the refuse container 200 are directed into the refuse compartment 30 by operation of the hopper actuators 418 in response to detecting an object in the contents of the refuse container 200 that should be kept separate from ordinary or regular refuse.

The display manager 1010 can be configured to generate display data for the display device 420 indicating a type of object detected and a location in the hopper 60 or the intermediate container 800 that the object is detected. The display manager 1010 can be configured to notify the operator of the refuse vehicle 10 regarding the detected object and provide a GUI that includes the image data of the cameras 402 or the cameras 1002 with the detected object highlighted. The controller 102 may also transmit, to the remote computing system 134, via the telematics 132, the customer location (e.g., the container location) and the object detected in the refuse container 200. The remote computing system 134 can be configured to use the received information in order to either charge the customer additional charges for the pickup of the detected object (e.g., additional charge for picking up and disposal of a freezer) or in order to provide training to the customer regarding which objects can be disposed of in the refuse container 200.

The packing tracker 1012 may be configured to use the results of the object detector 1006 and the image data in order to track a location within the refuse compartment 30 of one or more of the detected objects. For example, the packing tracker 1012 can be configured to estimate or monitor an amount of refuse that is loaded into the refuse compartment 30 based on image data provided by the cameras 1002 and the cameras 402. The packing tracker 1012 can also be configured to monitor points in time (e.g., based on fill amount of the refuse container 200) at which a detected object as provided by the object detector 1006 is loaded into the refuse compartment 30. The packing tracker 1012 may determine (e.g., estimate) a location within the refuse compartment 30 of the detected object (e.g., the hazardous or quarantine object) based on operations of a packer assembly 430 within the refuse compartment 30 that compacts the refuse. The packing tracker 1012 can also use feedback from a hopper fill sensor to identify a relative point at which the detected object is loaded in the refuse compartment 30 and predict a location within the refuse compartment 30 of the detected object. The packing tracker 1012 can be configured to predict the location of the detected object within the refuse compartment 30 by using the results of the object detector 1006 in combination with any of the functionality as described in greater detail with reference to: U.S. application Ser. No. 10/943,182, filed Sep. 16, 2004, issued as U.S. Pat. No. 7,108,473; U.S. application Ser. No. 10/389,195, filed Mar. 14, 2003, issued as U.S. Pat. No. 6,799,934; or U.S. application Ser. No. 18/342,343, filed Jun. 27, 2023, the entire disclosures of which are all incorporated by reference herein in their entireties. The object detector 1006 may have a list of objects (e.g., a database of detectable objects) that the object detector 1006 is configured to identify in the image data as well as a corresponding type (e.g., whether the detected object should be separated from other refuse).

The detection and sorting system 1000 can also be configured to achieve the detection of objects (e.g., hazardous objects, quarantine objects, objects of a particular type that should be kept separate from regular refuse) and operate to either move the detected objects into separate compartments, track the detected objects within the refuse compartment 30, or reject the objects by implementing any of the functionality as described in greater detail in U.S. application Ser. No. 16/758,834, filed Apr. 23, 2020, issued as U.S. Pat. No. 11,527,072, or U.S. application Ser. No. 16/851,196, filed Apr. 17, 2020, issued as U.S. Pat. No. 11,673,563, the entire disclosures of which are all incorporated by reference herein in their entireties.

The packing track 1012 can be configured to operate the packer 430 and lift cylinders 432 of the refuse vehicle to perform a dumping or ejection operation by raising the body 14 of the refuse vehicle 10 relative to the chassis 12 (e.g., operating the lift cylinders 432), and operating the packer 430 to drive discharge of the refuse in the refuse compartment 30. The packing tracker 1012 may operate the display device 420 to notify the operator regarding the location of the detected and tracked objects in the ejected load. The packing tracker 1012 can also implement autonomous or semi-autonomous transportation and ejection of portions of the load in the refuse compartment 30 at a first location, and portions of the load in the refuse compartment 30 where the detected object is predicted to be present at a second location.

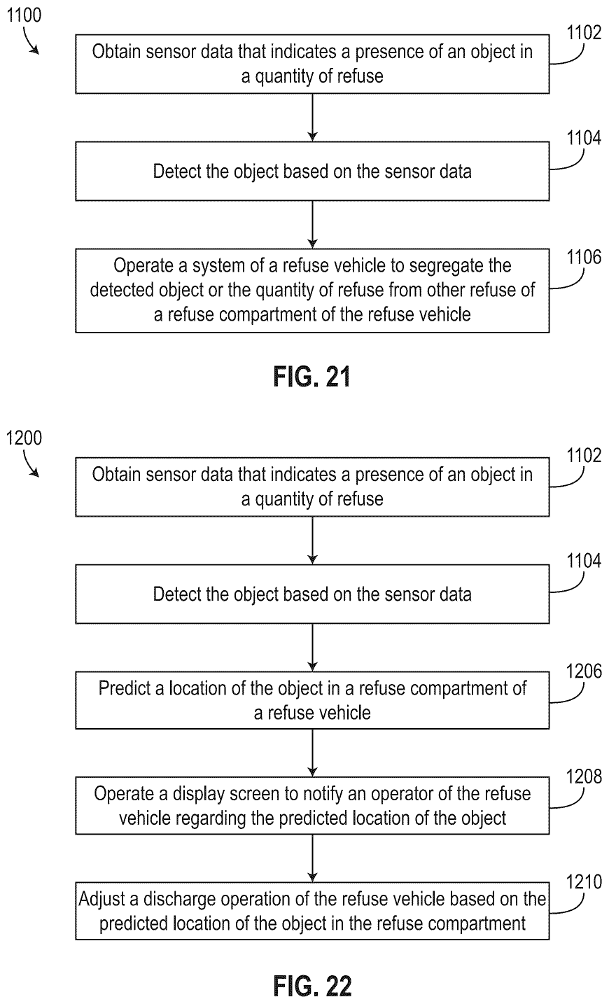

Referring to FIG. 21, a flow diagram of a process 1100 for quarantining or segregating hazardous or particular objects from regular refuse includes steps 1102-1106, according to some embodiments. The process 1100 may be performed by the detection and sorting system 1000 in order to separate certain objects such as cans of oil, appliances, etc., from regular refuse such as kitchen garbage, small items, etc. The process 1100 advantageously facilitates physically separating and quarantining objects from their respective loads of refuse either into a separate refuse compartment, or entirely quarantining the load of refuse from the customer's refuse container into the separate refuse compartment. The process 1100 can also be performed in order to reject the detected objects by placing them back at the customer's pickup spot.

The process 1100 includes obtaining sensor data that indicates a presence of an object in a quantity of refuse (step 1102), according to some embodiments. Step 1102 can be performed by obtaining image data from the cameras 1002 or the cameras 402 of the refuse vehicle 10. Step 1102 can also include wirelessly receiving image data from a camera that is positioned at the customer's refuse container. The image data may be image data of a hopper, the interior of the customer's refuse container, or an interior of an intermediate hopper or container.

The process 1100 includes detecting the object based on the sensor data (step 1104), according to some embodiments. Step 1104 can be implemented by the controller 102 by using a machine learning, artificial intelligence, or neural network technique to detect the object from a library of different objects. Step 1104 may include additionally identifying a position of the object relative to a position or location of the camera that obtains the image data.

The process 1100 includes operating a system of the refuse vehicle to move the detected object or the quantity of refuse from other refuse of a refuse compartment of the refuse vehicle (step 1106), according to some embodiments. Step 1106 can be performed by the controller 102 by operating the hopper actuators 418 to direct the entire load (e.g., the quantity) of refuse from the customer's refuse container into a separate refuse compartment (e.g., the refuse compartment 30b). Step 1106 can also be performed by the controller 102 by operating the robotic arm implement 700 based on the image data of the detected object to remove the detected object from the quantity of refuse of the customer's refuse container and to place the object into a separate hopper location or into a separate refuse compartment (e.g., the refuse compartment 30b). Step 1106 can also be performed by the controller 102 by operating the robotic arm implement 700 to remove the detected object from the hopper 60 of the refuse vehicle 10 and return the object to the customer's pickup location (e.g., rejecting the pickup of the object).

Referring to FIG. 22, a flow diagram of a process 1200 for tracking a detected object in a load of a refuse vehicle includes steps 1102-1104 and steps 1206-1210, according to some embodiments. The process 1200 can be implemented by the detection and sorting system 1000 similarly to the process 1100. The process 1200 may be performed instead of the process 1100, for example, if the refuse vehicle 10 is not equipped with multiple refuse compartments.

The process 1200 includes steps 1102-1104 that are substantially the same as steps 1102-1104 of process 1100. The process 1200 also includes predicting a location of the object in a refuse compartment of the refuse vehicle (step 1206), according to some embodiments. Step 1206 may be performed by the controller 102 by implementing the functionality of the packing tracker 1012. In some embodiments, step 1206 includes using various sensor data that indicates a quantity of refuse that has been packed into the refuse compartment in combination with a point at which the detected object is packed into the refuse compartment. For example, if the detected object is packed into the refuse compartment at the refuse vehicle's last pickup, the detected object may be predicted to be at distal end of the refuse compartment. Similarly, if the detected object is packed into the refuse compartment at the refuse vehicle's first pickup, the detected object may be predicted to be at a proximate end of the refuse compartment.

The process 1200 includes operating a display screen to notify an operator of the refuse vehicle regarding the predicted location of the object (step 1208), according to some embodiments. Step 1208 may be performed by the controller 102 by implementing the functionality of the display manager 1010 or the packing tracker 1012 in order to display a graphical representation of the load of the refuse compartment and the predicted location of the object within the load of the refuse compartment.

The process 1200 includes adjusting a discharge operation of the refuse vehicle based on the predicted location of the detected object in the refuse compartment (step 1210), according to some embodiments. Step 1210 can include autonomously or semi-autonomously ejecting portions of the loaded refuse in the refuse compartment to different locations. For example, portions of the refuse compartment where the object is predicted to be located may be ejected at a separate location. In some embodiments, step 1210 includes operating a display device to notify an operator when the detected object is being ejected. Step 1210 may also include transmitting a signal to a nearby robotic arm implement that is autonomously or manually controlled in order to grab and move the detected object after is it ejected from the refuse vehicle 10.

### Refuse Profile Determination and Route Planning

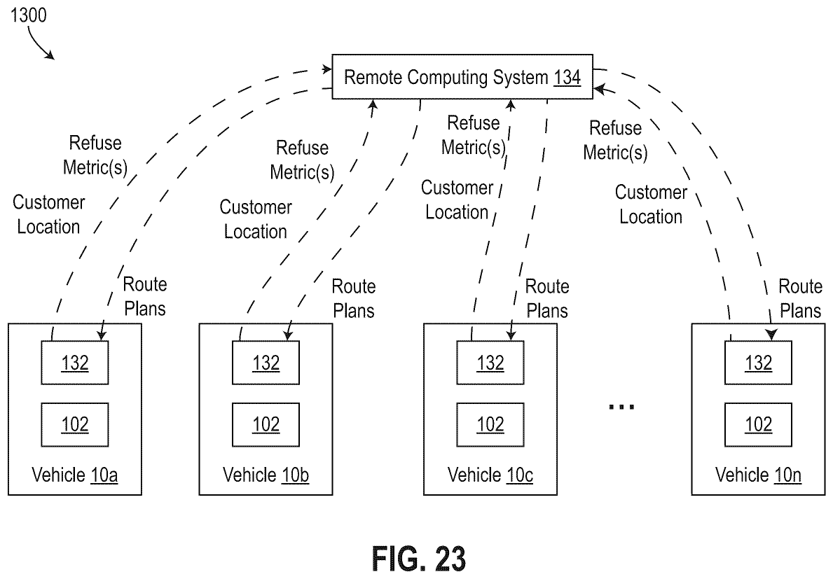

Referring to FIG. 23, a route planning system 1300 for one or more refuse vehicles 10 can be implemented by the remote computing system 134. The remote computing system 134 is configured to obtain, from a fleet of refuse vehicles 10, shown as refuse vehicle 10a, refuse vehicle 10b, refuse vehicle 10c, etc., one or more refuse metrics and corresponding customer locations. The remote computing system 134 may obtain the refuse metrics and the corresponding customer locations from the telematics units 132 of the vehicles 10. The remote computing system 134 may aggregate the refuse metrics obtained from the refuse vehicles 10 and update or generate routes for the refuse vehicles 10 to optimize fuel consumption, total time, etc., or various other objectives. The refuse metrics can be obtained from the vehicles 10 and may indicate quantity of refuse obtained from each customer location or from each refuse container 200, quantity of refuse obtained from a particular geographical region (e.g., a neighborhood), quality of refuse (e.g., whether contaminants are detected, whether different types of refuse are placed in the incorrect refuse containers such as garbage or organic material in recycling receptacles, whether refuse containers are overpacked, etc.). The remote computing system 134 can use the refuse metrics and the corresponding customer locations in order to identify trends or patterns of different customers, regions, neighborhoods, etc., and adjust the route plans to account for the trends. For example, if a first neighborhood typically has a larger quantity of refuse than a second neighborhood, the remote computing system 134 may update the routes to plan for a greater fill level of the refuse vehicle that services the first neighborhood when exiting the first neighborhood. In this way, the routes for the refuse vehicles 10 can be planned based on the identified trends or patterns of various customers.

The remote computing system 134 may communicate with each of the refuse vehicles 10 via their telematics units 132 in real-time and may store collected data (e.g., collected refuse metrics and tagged customer location or pickup site) in order to build up profiles (e.g., customer-specific profiles, neighborhood or geographic region specific profiles, profiles for pre-planned routes or legacy routes, etc.). The remote computing system 134 can use the profiles in order to update or optimize the routes and dispatching of the refuse vehicles 10. The refuse metrics can be obtained at the local controllers 102 of the refuse vehicles 10 based on sensor data obtained from various sensors on the refuse vehicles 10. In some embodiments, the remote computing system 134 is configured to also determine recommended autonomous control parameters or settings for each of the refuse vehicles 10 at different locations along the route plans.

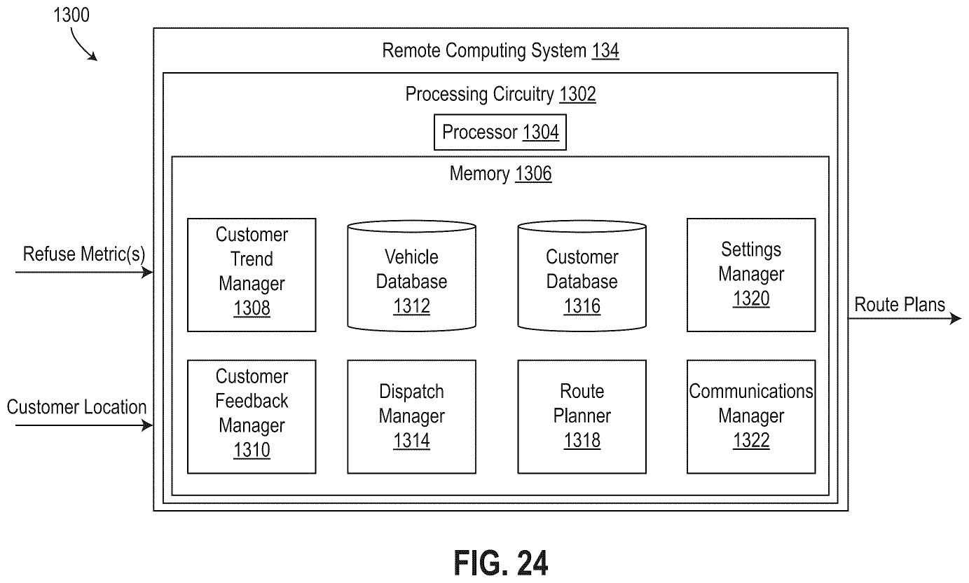

Referring to FIG. 24, the remote computing system 134 includes processing circuitry 1302 including a processor 1304 and memory 1306. Processing circuitry 1302 can be communicably connected with a communications interface of remote computing system 134 such that processing circuitry 1302 and the various components thereof can send and receive data via the communications interface. Processor 1304 can be implemented as a general purpose processor, an application specific integrated circuit (ASIC), one or more field programmable gate arrays (FPGAs), a group of processing components, or other suitable electronic processing components.

Memory 1306 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1306 can be or include volatile memory or non-volatile memory. Memory 1306 can include database components, object code components, script components, or any other type of information structure for supporting the various activities and information structures described in the present application. According to some embodiments, memory 1306 is communicably connected to processor 1304 via processing circuitry 1302 and includes computer code for executing (e.g., by at least one of processing circuitry 1302 or processor 1304) one or more processes described herein.

The memory 1306 includes a customer trend manager 1308, a customer feedback manager 1310, a vehicle database 1312, a dispatch manager 1314, a customer database 1316, a route planner 1318, a settings manager 1320, and a communications manager 1222, according to some embodiments. The customer trend manager 1308 is configured to use the collected refuse metrics and customer locations to build customer-specific or region-specific profiles. The customer feedback manager 1310 is configured to use the customer-specific profiles or the region-specific profiles in order to identify customers that require recommendations, feedback, or training on appropriate refuse disposal practices. The vehicle database 1312 may store information regarding various of the vehicles 10 in the fleet of vehicles. For example, the vehicle database 1312 can store information regarding any of the location of the vehicles 10, the type of vehicles 10 (e.g., recycling vehicles, garbage trucks), the configuration of the vehicles 10 (e.g., side loaders, front loaders, rear loaders, front loaders with intermediate cans), available systems on the vehicles 10 (e.g., vision systems, contaminant detection systems, etc.), characteristics or metrics of the vehicles 10 (e.g., fuel efficiency, system data indicating health of the vehicles 10, odometer readings, service intervals, etc.), routes that the vehicles 10 are assigned to complete, drivers or driver schedules for the vehicles 10, deployment times of the vehicles 10, etc.

The dispatch manager 1314 is configured to use the results of the route planner 1318 to ready and deploy various refuse vehicles 10 along their routes. The customer database 1316 can be configured to store profiles that are generated by the customer trend manager 1308. The route planner 1318 is configured to access data in the vehicle database 1312 and the customer database 1316 to generate or adjust legacy routes for the refuse vehicles 10 based on the vehicle database 1312 and the customer database 1316. The settings manager 1320 is configured to use the routes provided by the route planner 1318, the data of the vehicle database 1312, and the profiles of the customer database 1316 in order to determine various settings for the vehicles 10 at various locations along the routes. The communications manager 1322 is configured to facilitate the communications between the remote computing system 134 and the telematics units 132 of each of the refuse vehicles 10.

The customer trend manager 1308 may be configured to track the refuse quantity and refuse quality (e.g., the refuse metrics) for each customer location over time. The customer trend manager 1308 can be configured to determine an average quantity or weight of the refuse collected from the customer by averaging the weights or quantities of refuse at each pickup at the customer's location over time. The customer trend manager 1308 may also be configured to determine a frequency of poor refuse quality (e.g., a frequency that the refuse collected at the customer is contaminated). The frequency of poor refuse quality may be expressed in terms of percentage (e.g., 20% of the collections at the customer are contaminated) or a number of occurrences (e.g., the customer has had 15 contaminated loads over the past year).

For example, the customer trend manager 1308 may obtain a weight or quantity of refuse w₁ a first time that a particular refuse vehicle 10 performs a collection along a route at a first customer C₁. The customer trend manager 1308 can subsequently obtain additional weight or quantity values w₂, w₃, etc., as the refuse vehicle 10 performs the collection along the route at future times. The customer trend manager 1308 may determine an average or mean weight (or quantity such as in terms of volume) based on the collected weights or quantities of refuse at the customer. The average or mean weight or quantity of refuse may also be predicted by the customer trend manager 1308 using a statistical approach to identify a confidence of the predicted mean or average weight. In some embodiments, the customer trend manager 1308 is configured to provide the average or mean weight or quantity of refuse and an identification of the customer to the customer database 1316 as the customer profile.

The customer trend manager 1308 can also be configured to store the frequency or likelihood (e.g., percentage probability) in the customer database 1316 as a portion of the customer profile. In this way, the customer-specific profile can reflect a typical amount of refuse that a customer typically has in their refuse container 200 as well as a predictability of a likelihood of a contaminant in the customer's refuse container 200. The customer trend manager 1308 may also be configured to identify times of the month or year that the quantity or weight of refuse in the customer's refuse container 200 increases or decreases. The customer trend manager 1308 can also be configured to predict, based on a detection that the customer's refuse container 200 is not present during one route collection process, a predicted weight or quantity of refuse that will be in the customer's refuse container 200 the next collection route process (e.g., the next week).

The customer trend manager 1308 can also be similarly configured to generate geographical area profiles using similar techniques as used to generate the customer-specific profiles. The geographical area profiles (e.g., a block, a county, a particular portion of a collection route, a particular neighborhood, etc.) can include an average total quantity or weight of refuse that is typically collected. The geographical area profiles can also include a likelihood that at least one of the customer will have a contaminant present in their refuse container 200. The customer trend manager 1308 may use a probability technique to determine, based on the likelihood of each of the customers within the geographical area, a likelihood that at least one of the customers will have a contaminant in their refuse containers 200, a likelihood that at least two of the customers will have a contaminant in their refuse containers 200, etc. In some embodiments, the customer trend manager 1308 is also configured to predict or estimate a number of customers (e.g., a number of refuse containers 200) that will likely have a contaminant present in their refuse containers 200. The customer trend manager 1308 can be configured to track quantities of refuse added to the refuse compartment of the refuse vehicle 10 as the refuse vehicle 10 is within the geographical area in order to determine cumulative or total refuse that is added to the refuse vehicle 10 when performing refuse collection throughout the geographical area. In some embodiments, the customer trend manager 1308 is configured to use sensor feedback from the refuse vehicle 10 indicating weight or fill level of the refuse compartment 30 of the refuse vehicle 10 as the refuse vehicle 10 enters the geographical area as compared to the weight or fill level of the refuse compartment 30 of the refuse vehicle 10 when the refuse vehicle 10 leaves the geographical area. A difference or comparison between the weight or fill level of the refuse compartment 30 when entering the geographical area relative to the weight or fill level of the refuse compartment 30 when leaving the geographical area indicates total refuse (e.g., in terms of weight or quantity) collected in the geographical area.

The customer feedback manager 1310 may use the customer-specific profiles in the customer database 1316 to identify customers that may require training regarding proper refuse disposal practices. For example, the customer feedback manager 1310 may compare the frequency, likelihood, or number of times that each of the customers have placed contaminants in their refuse containers 200 and, in response to the frequency, likelihood, or the number of times that one or more of the customers have placed contaminants in their refuse containers 200 exceeding a corresponding threshold, identifying that the one or more customers require additional training or instruction on proper refuse practices. Similarly, the customer feedback manager 1310 may identify specific types of contaminants and may schedule an alert (e.g., a mailed notice, a broadcast, a text message, etc.) to provide to the customer that the specific types of contaminants (e.g., refrigerators, tires, cans of oil, etc.) should not be placed in refuse containers 200. In some embodiments, the customer feedback manager 1310 is configured to receive refuse metrics that indicate if different types of refuse are placed in the incorrect refuse containers 200 (e.g., if garbage is placed in recycling containers). The customer feedback 1310 can similarly be configured to generate an alert to notify customers that routinely put garbage or non-recyclable items into recycling containers regarding what types of refuse can be recycled, and which are garbage.

In some embodiments, the customer feedback manager 1310 is also configured to use a threshold (e.g., the same threshold used to generate the alerts, or a separate, higher threshold) to identify customers that routinely have contaminants in their refuse containers 200. If certain customers regularly have contaminants in their refuse containers, the customer feedback manager 1310 (or the customer trend manager 1308) may update the customer database 1316 to include an indication that the certain customer's refuse containers 200 should be collected by a separate refuse vehicle 10 in order to reduce a likelihood of contamination of the refuse vehicle 10 that performs collection at the geographical area of the certain customers.

The route planner 1318 is configured to use the profiles from the customer database 1216 in order to determine (e.g., generate) or adjust routes. The route planner 1318 can also be configured to use the data from the vehicle database 1312 to determine or adjust the routes. For example, the route planner 1318 can be configured to use information from the customer database 1316 to predict an amount of refuse collected along a route and either adjust the starting and end points of the route, the shape of the route, etc., based on the predicted amount of refuse collected along the route. The route planner 1318 can also be configured to select an appropriate refuse vehicle from the vehicle database 1312 based on requirements (e.g., accessibility of the refuse containers) and based on the capabilities of the refuse vehicles (e.g., the capacity of the refuse vehicles 10 and the expected or predicted amount of refuse to be collected over the route based on the customer-specific profiles in the customer database 1316). The route planner 1318 is configured to determine the routes for multiple areas along different streets such that all subsets of geographical areas in an overall region (e.g., neighborhoods, etc.) are completed. The route planner 1318 may provide the routes for each of multiple refuse vehicles 10 in the fleet to the communications manager 1322 and the settings manager 1320. The communications manager 1322 can provide the routes to the refuse vehicles 10 (e.g., to the respective telematics units 132) for use in autonomously or semi-autonomously operating the refuse vehicles 10 according to the route. The routes may include indications of which roads to travel, which turns to take, where the pickup locations are along the route, etc.

The settings manager 1320 is configured to determine one or more settings or parameters for the refuse vehicles 10 at various points along the routes assigned to the corresponding refuse vehicles 10. The settings manager 1320 can predict times along the routes, based on a predicted cumulative load or quantity of refuse in the refuse compartment 30 of the refuse vehicle 10, to deploy one or more auxiliary axles. For example, the settings manager 1320 can be configured to predict that at a specific location along the route, the refuse vehicle 10 will have a weight of refuse that approaches a capacity threshold, and that an auxiliary axle should be deployed to support the weight adequately. The weight of refuse in the refuse compartment 30 of the refuse vehicle 10 may be referred to herein as the payload. The settings manager 1320 can also be configured to identify, based on the predicted payload, locations along the route to implement regenerative braking, adjust pressure of the auxiliary axles, adjust a suspension setting, adjust an autonomous driving parameter, or implement traction control (e.g., locations that typically have slippery surfaces). The payload may be predicted by the settings manager 1320 based on the customer-specific profiles stored in the customer database 1316. The recommended settings and corresponding locations along the routes for each of the refuse vehicles 10 may be provided to the refuse vehicles 10 as a part of the route plans.

It should be understood that while the functionality of the remote computing system 134 as described herein with reference to FIGS. 23-24 assumes that the payload of the refuse vehicles 10 is increasing along the route, the remote computing system 134 can also implement similar techniques for fleets of vehicles such as delivery vehicles where the payload decreases along the route. The adjustments to the settings as implemented by the settings manager 1320 may therefore be performed in reverse (e.g., predicting the payload to decrease along the routes and adjusting the settings appropriately).

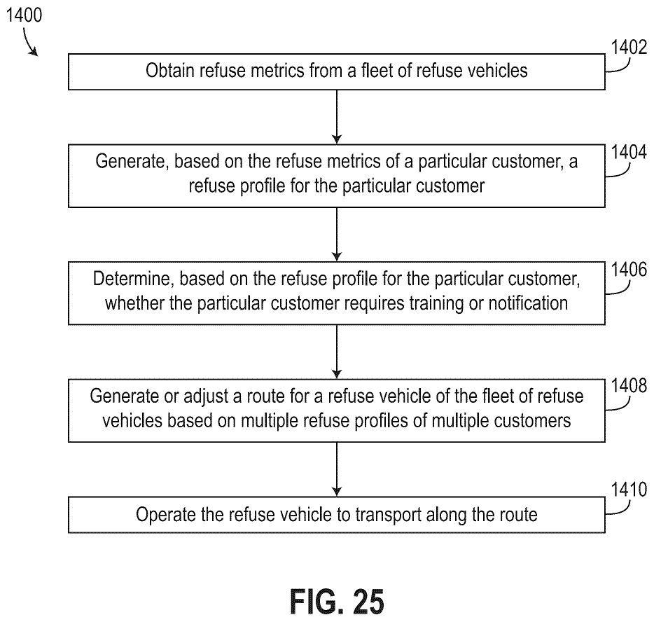

Referring to FIG. 25, a flow diagram of a process 1400 for generating refuse profiles based on refuse metrics includes steps 1402-1410, according to some embodiments. The process 1400 can be performed by the remote computing system 134. The process 1400 can also be performed at least partially by the controllers 102 of refuse vehicles 10. The process 1400 facilitates the generation of profiles for different customers. Route planning or adjustments to operation of the refuse vehicles 10 can be implemented by the remote computing system 134 or the controllers 102 based on the profiles.

The process 1400 includes obtaining refuse metrics from a fleet of refuse vehicles (step 1402), according to some embodiments. The step 1402 may be performed by the remote computing system 134 by obtaining refuse metrics from the telematics units 132 of the refuse vehicles 10. In some embodiments, the refuse metrics include weight estimations or measurements of a payload of the refuse vehicle 10 as the refuse vehicle 10 collects refuse from different customers. For example, the refuse metrics may include changes or an identification of a weight of refuse that is dumped into the refuse vehicle 10 at each customer. The refuse metrics can also include results from the stream sorting system 400 (e.g., whether the incorrect type of refuse was detected in the refuse container 200) and the detection and sorting system 1000 (e.g., whether one or more types of objects such as appliances are detected in the refuse). The refuse metrics can be obtained for a geographical area (e.g., a neighborhood) or each customer.

The process 1400 includes generating, based on the refuse metrics of a particular customer, a refuse profile for the particular customer (step 1404), according to some embodiments. The refuse profile for the particular customer can include an average or mean weight of refuse or recycling expected to be obtained at the next pickup. The refuse profile for the particular customer can also include a frequency or a predicted likelihood that the customer's refuse will be contaminated or require quarantining. Step 1404 can be performed by the remote computing system 134 or by the controller 102. Step 1404 can include generating a refuse profile for each customer along a route or each customer served by any of the refuse vehicles 10 of the fleet.

The process 1400 includes determining, based on the refuse profile for the particular customer, whether the particular customer requires training or notification (step 1406), according to some embodiments. Step 1406 can be implemented by comparing the average or mean weight of refuse collected at the customer's location to a threshold amount, and if the customer routinely exceeds a weight limit, determining that the customer typically overpacks the refuse container 200 and should be instructed to not pack the refuse as tightly. Similarly, if the frequency or likelihood that the customer's refuse will be contaminated exceeds a corresponding threshold, step 1406 can include determining that the customer should be instructed or warned regarding proper refuse operations (e.g., what objects can and can not be thrown in the garbage, which bins recycling should be placed into, what objects are and are not recyclable, etc.). In some embodiments, step 1406 includes adding the customer to a quarantine list so that the customer's refuse is picked up by a separate refuse vehicle 10 so as not to contaminate the rest of the refuse in a different refuse vehicle 10. Step 1406 can be performed for each customer, or may be performed for entire geographical areas.

The process 1400 includes generating or adjusting a route for a refuse vehicle of the fleet of refuse vehicles based on multiple refuse profiles of multiple customers (step 1408), according to some embodiments. Step 1408 can be performed by the remote computing system 134 based on the results of steps 1402-1406. For example, the route may be determined based on a predicted location or time along the route at which the refuse vehicle 10 is predicted to be completely filled or filled to capacity (e.g., based on the refuse profiles of each of the customers). Step 1408 can also include identifying an amount of time that it takes a refuse vehicle to perform a particular route, and can include generating route for the fleet of refuse vehicles 10 to reduce total amount of time to collect all of the refuse in a geographic area. Step 1408 can also include adjusting a route to remove specific customers from the route (e.g., quarantining customers) and scheduling pickup by a separate refuse vehicle 10. Step 1408 can include using a known capacity of each of the refuse vehicles 10 and scheduling the refuse vehicles 10 to collect refuse from different customers based on the known capacity and the predicted total refuse for the customers along the route using the refuse profile for the customers.

The process 1400 includes operating the refuse vehicle to transport along the route (step 1410), according to some embodiments. Step 1410 can be performed by the controller 102 to autonomously or semi-autonomously control the refuse vehicle 10 along the route. Step 1410 can include providing route plans from the remote computing system 134 to the controller 102 of the refuse vehicle 10. Step 1410 can include operating a driveline, steering system, braking system, etc., of the refuse vehicle according to suggested parameters or route of the route plan. In some embodiments, step 1410 includes using real-time feedback from sensors or system of the refuse vehicle 10 (e.g., a GPS system) to transport the refuse vehicle 10 along the route.

### Payload Adaptive Chassis Control

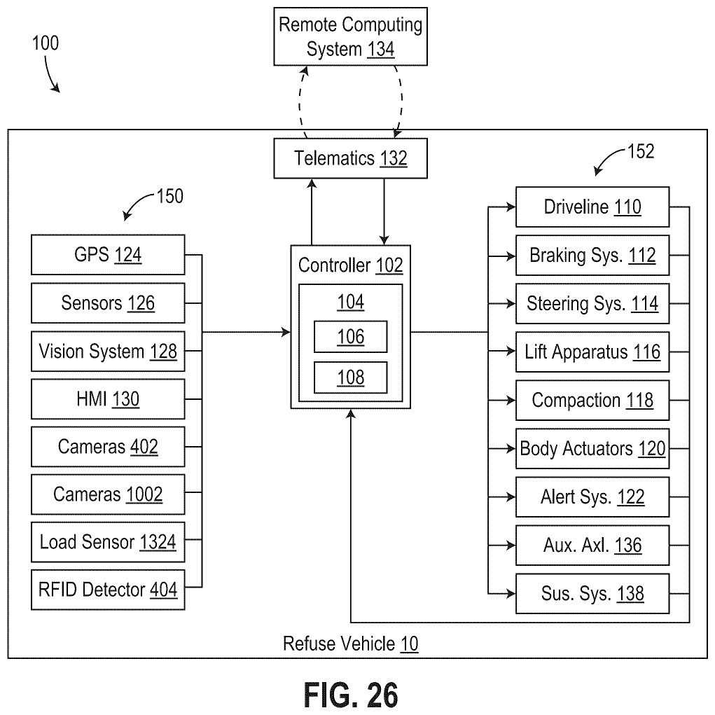

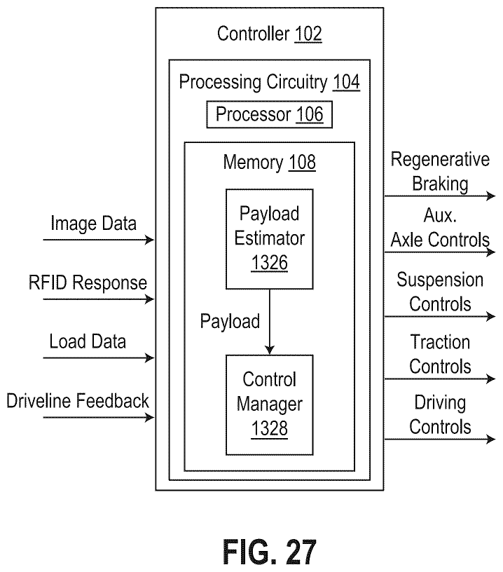

Referring to FIGS. 26-27, the controller 102 of the refuse vehicle 10 may implement adjustments to various parameters or operations of the vehicle 10 based on payload currently present in the refuse compartment 30 of the refuse vehicle 10. The controller 102 is configured to implement a payload estimator 1326 and a control manager 1328. The controller 102 is configured to obtain any of the image data from the cameras 402 or the cameras 1002, the RFID response from the RFID detector 404, etc. The payload estimator 1326 may be configured to implement any of the functionality of image analysis 406, the decoder 498, the RFID manager 410, or the pickup planner 412 as described in greater detail above with reference to FIG. 8 in order to predict a quantity or weight of refuse added to the refuse compartment 30 and therefore predict or estimate payload of the refuse compartment 30 (e.g., cumulative weight of refuse). The payload estimator 1326 may also be configured to implement any of the functionality of the object detector 1006 or the packing tracker 1012 as described in greater detail above with reference to FIG. 20 in order to predict or estimate payload of refuse in the refuse compartment 30. In some embodiments, the payload estimator 1326 is configured to implement any of the functionality of the hopper fill sensor in order to predict or estimate the payload as described in greater detail in U.S. application Ser. No. 18/342,343, filed Jun. 27, 2023, the entire disclosure of which is incorporated by reference herein in its entirety.

The payload estimator 1326 can also be configured to use load data obtained from the load sensor 1324 to estimate the payload. The load sensor 1324 may be positioned between the frame 12 and the body 14 and indicates weight of the refuse compartment 30. The load sensor 1324 may be a strain gauge or a load cell that directly measures current weight of refuse loaded into the refuse compartment 30.

The payload estimator 1326 is configured to provide an estimate or reading of the payload to the control manager 1328 for use in adaptively adjusting one or more operations of the refuse vehicle 10. In particular, the control manager 1328 can use the payload provided by the payload estimator 1326 in order to implement regenerative braking. In some embodiments, the control manager 1328 is configured to activate and use regenerative braking in addition to friction braking or adjust an amount of braking provided based on the payload (e.g., in response to the payload exceeding a threshold value). The control manager 1328 can also be configured to deploy an auxiliary axle 136 in response to the payload reaching a threshold value, shown as auxiliary axle controls. The control manager 1328 may also adjust (e.g., increase) the pressure of the auxiliary axle 136 as the payload increases in order to account for changes in the payload of the refuse vehicle 10. The control manager 1328 may also adjust the pressurization (e.g., increase) of one or more suspension components of a suspension system 138 based on the payload, shown as suspension controls. For example, the control manager 1328 may increase the pressure of the suspension components (e.g., the dampers, the hydraulic cylinders, etc.) of the suspension system 138 as the payload of the refuse vehicle 10 increases in order to account for the increased payload and reduce a likelihood that the suspension system 138 will bottom out due to the increased weight. The control manager 1328 may be configured to adjust one or more autonomous driving parameters of an autonomous driving system of the refuse vehicle 10 based on the payload. In some embodiments, the driving controls are generated by the control manager 1328 based on the adjusted autonomous driving parameters. The autonomous driving parameters can include acceleration parameters or deceleration (e.g., braking) parameters, speed at which turns are taken, stopping distance, etc., in order to account for the increased (or decreased, in the case of delivery vehicles) payload of the refuse vehicle 10 as the refuse vehicle 10 performs route collection.

The control manager 1328 can also be configured to implement traction control (e.g., slip control) for the refuse vehicle 10, shown as traction controls. The traction controls can be adjusted or implemented by the control manager 1328 based on the payload. For example, the traction control may increase in sensitivity (e.g., conditions that activate traction control) as the payload increases to account for the increased payload.

The controller 102 may be configured to provide the regenerative braking controls to the braking system 112 or to the driveline 110 of the refuse vehicle 10. For example, the driveline 110 may include the multi-mode electromechanical variable transmission as described in greater detail in U.S. patent application Ser. No. 16/275,059, filed Feb. 13, 2019, issued as U.S. Pat. No. 10,982,736, the entire disclosure of which is incorporated by reference herein. In some embodiments, the auxiliary axle 136 is a selectively deployable axle that transitions between a raised position and a lowered position in which tractive elements of the auxiliary axle 136 contact the road or ground surface beneath the refuse vehicle 10 in order to provide improved support for the refuse compartment 30.

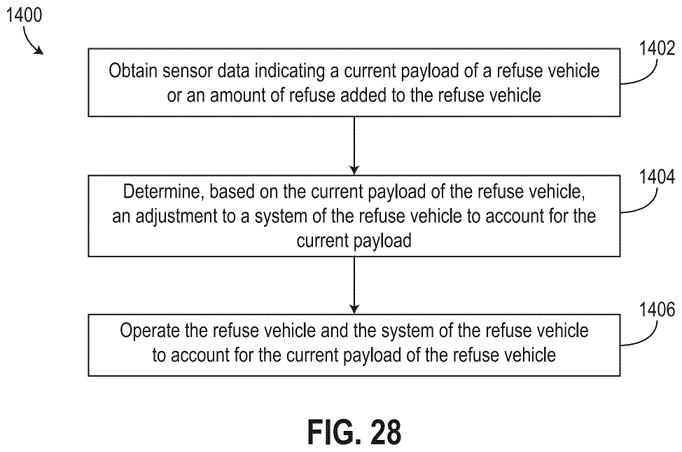

Referring to FIG. 28, a flow diagram of a process 1400 for operating a refuse vehicle to account for a current payload includes steps 1402-1406, according to some embodiments. In some embodiments, the process 1400 is implemented locally at the controller 102 based on real-time feedback from various sensors (e.g., cameras, load cells, etc.) of the refuse vehicle 10.

The process 1400 includes obtaining sensor data indicating a current payload of a refuse vehicle or an amount of refuse added to the refuse vehicle (step 1402), according to some embodiments. In some embodiments, step 1402 is performed by the controller 102 by obtaining image data of refuse from a camera of a customer's refuse container 200, from cameras disposed on the hopper 60, etc. In some embodiments, the image data may indicate an amount of refuse that is within the customer's refuse container 200 or emptied into the hopper 60 during a collection action at a customer site. The controller 102 may sum or add the total amount of refuse obtained and added to the refuse compartment 30 at each pickup and can predict a fill level of the refuse compartment 30 based on the total amount of refuse obtained. The fill level of the refuse compartment 30 can be used as an input to a prediction calculation to estimate a weight or the current payload of the refuse in the refuse compartment 30 of the refuse vehicle 10. In some embodiments, the sensor data is load data or a direct measurement of a weight of the refuse compartment 30 (e.g., from a strain gauge, a load cell, etc.).

The process 1400 includes determining, based on the current payload of the refuse vehicle, an adjustment to a system of the refuse vehicle to account for the current payload (step 1404), according to some embodiments. Step 1404 may be implemented locally by the controller 102 by comparing the current payload to a variety of different trigger thresholds or using different relationships in order to determine adjustments to the system. The adjustment to the system may include initiating or adjusting regenerative braking of the refuse vehicle 10 (e.g., of the driveline 110), activating an auxiliary axle, increasing auxiliary axle or axle pressure, adjusting pressurization of a suspension component, adjusting an autonomous driving parameter, or adjusting traction control of the refuse vehicle 10 in order to account for the current payload.

The process 1400 includes operating the refuse vehicle and the system of the refuse vehicle to account for the current payload of the refuse vehicle (step 1406), according to some embodiments. In some embodiments, step 1406 is performed by the controller 102 of the refuse vehicle 10 by generating controls for various driving, steering, refuse collection, lift apparatuses, compaction systems, etc., of the refuse vehicle 10 in order to implement autonomous or semi-autonomous refuse collection. Advantageously, process 1400 can be performed in order to implement payload adaptive control for the refuse vehicle 10.

### Route Planning

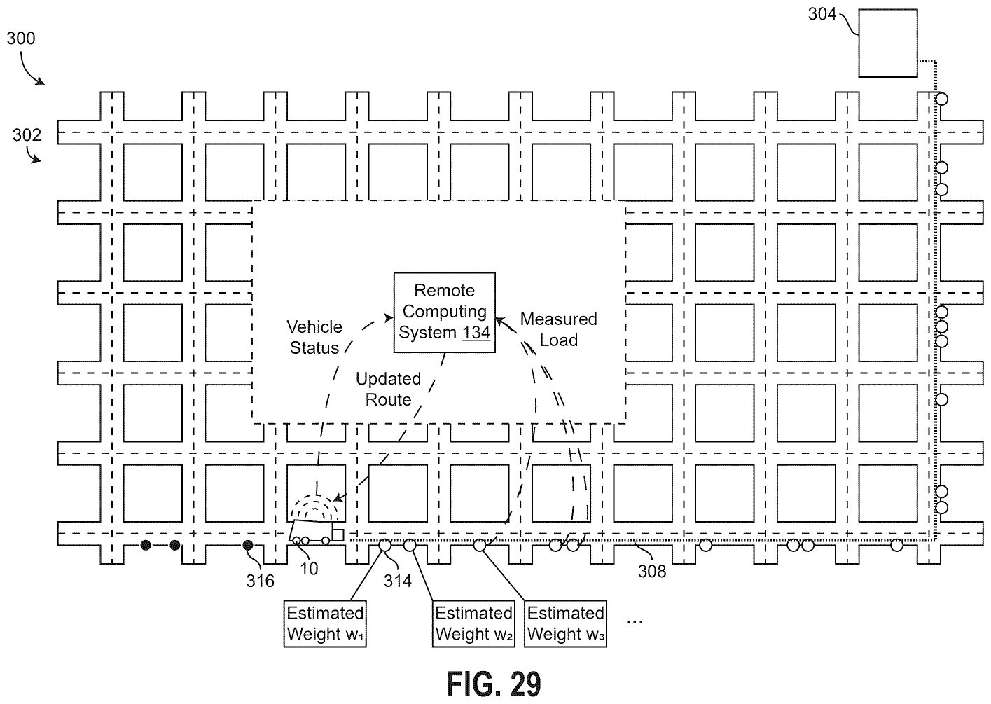

Referring to FIGS. 23-24 and 29-30, the remote computing system 134 may receive, from the telematics unit 132 of the refuse vehicle 10, a current location, status, etc., of the refuse vehicle 10. The remote computing system 134 may also communicate with wireless transceivers of refuse containers 200 at the future stops along the route 308 of the refuse vehicle 10. In some embodiments, the remote computing system 134 is configured to obtain a current location of the refuse vehicle 10 from the telematics unit 132 of the refuse vehicle 10 and a current fill level of the refuse compartment 30 of the refuse vehicle 10. The remote computing system 134 can also use the stored customer-specific profiles in order to predict an amount of refuse in each of the refuse container 200 at the future locations 314 along the route 308. In some embodiments, the remote computing system 134 is configured to receive measurements indicating a level of the refuse in the refuse containers 200 from the wireless transceivers of the refuse containers 200.

The remote computing system 134 may use the provided vehicle status (e.g., the vehicle location, the fill level) in combination with predicted or measured cumulative amount of refuse to be collected along the remainder of the route 308 to predict if the refuse vehicle 10 has sufficient capacity to complete the route 308. If the refuse vehicle 10 does not have sufficient capacity to complete the route 308, the remote computing system 134 may redirect the refuse vehicle 10 to a dump location and redirect a different refuse vehicle 10 to complete the route 308, or route the refuse vehicle 10 to finish the route 308 once the refuse in its refuse compartment 30 are dumped. The remote computing system 134 can be configured to predict the rest of the route, a location at which the refuse vehicle 10 will need to dump its load, a location a long the route 308 at which the refuse vehicle 10 should go to a transfer station, etc. The remote computing system 134 may provide the updated route or the rest of the route 308 to the refuse vehicle 10 via the telematics unit 132 of the refuse vehicle 10.

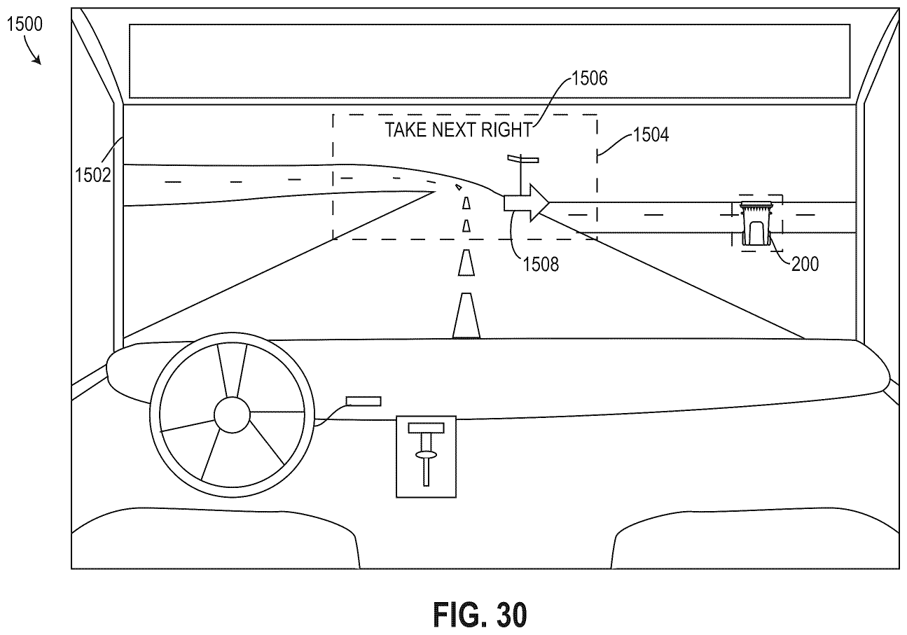

Referring to FIG. 30, the refuse vehicle 10 may be equipped with a heads up display (HUD) on a windshield 1502 of the cab 16. The HUD on the windshield 1502 may be configured to provide graphical displays as the refuse vehicle 10 travels along the route. The HUD on the windshield 1502 may be configured to provide an augmented reality overlay and display notifications of a next turn to take along the route. For example, as shown in FIG. 30, the HUD on the windshield 1502 includes a textual indication 1506 to take the next right, and a graphical indication, shown as arrow 1508 directing the refuse vehicle 10 to take the next right. The textual indication 1506 and the arrow 1508 may be provided within a display area 1504 of the windshield 1502. The HUD on the windshield 1502 may also highlight the refuse container 200 at the next pickup location to increase the conspicuity of the next pickup.

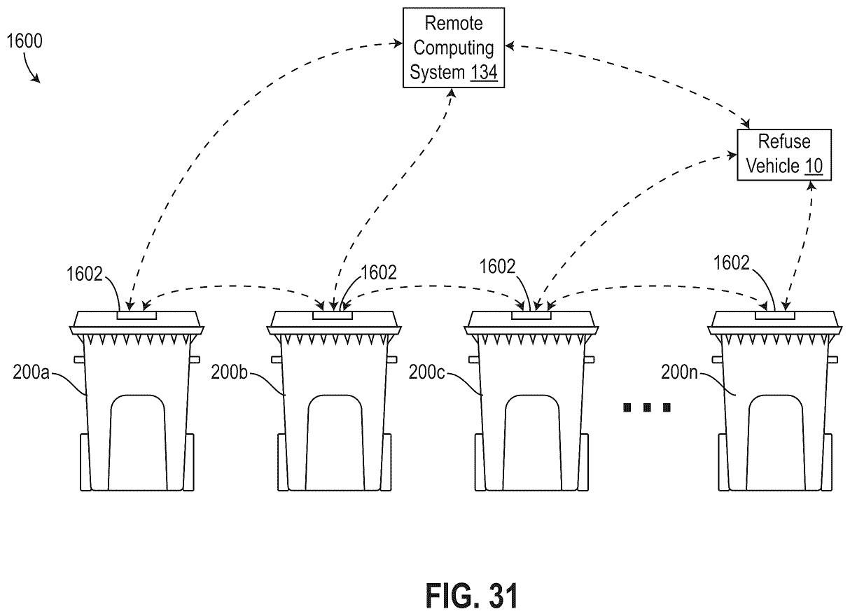

Referring to FIG. 31, the refuse containers 200 can each include a wireless transceiver 1602 that form a mesh network 1600 by communicating with each other, with nearby refuse vehicles 10, and with the remote computing system 134. The mesh network 1600 may be a WiFi mesh network. The wireless transceivers 1602 may also be configured to communicate via a mobile network using cellular dongles. The wireless transceivers 1602 may communicate a fill level of the refuse container 200 and a position of the refuse container 200 to the remote computing system 134. The remote computing system 134 may use the reported fill level and position of each of the refuse containers 200 in combination with the vehicle status provided by the refuse vehicle 10 in order to perform the route planning (e.g., to determine if the refuse vehicle 10 has sufficient capacity to collect the rest of the refuse in the refuse containers 200). The refuse containers 200 may include low energy Bluetooth tags and can be configured to communicate on a communications system with the refuse vehicles 10 and the remote computing system 134 similar to the communications system described in greater detail in U.S. application Ser. No. 17/576,813, filed Jan. 14, 2022, the entire disclosure of which is incorporated by reference herein.

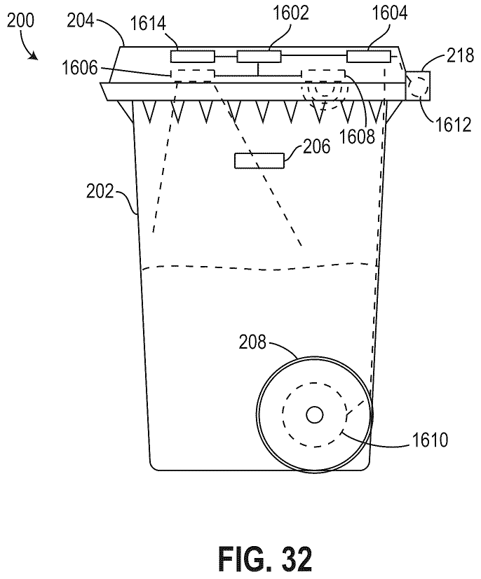

Referring to FIG. 32, the refuse container 200 may include the wireless transceiver 1602 (e.g., integrated into a control unit), a power source 1604 (e.g., a battery), a camera 1606, and an ultrasonic sensor 1608. In some embodiments, the refuse container 200 includes one of the camera 1606 or the ultrasonic sensor 1608. The ultrasonic sensor 1608 and the camera 1606 are configured to draw power from the power source 1604 and determine a fill level of the refuse container 200. In some embodiments, the ultrasonic sensor 1608 or the camera 1606 provide their results to the wireless transceiver 1602. The wireless transceiver 1602 is configured to provide the results of the ultrasonic sensor 1608 or the camera 1606 to the remote computing system 134. In some embodiments, the refuse container 200 also includes a position detector 1614 that is configured to provide a position of the refuse container 200 to the wireless transceiver 1602 for transmission to the remote computing system 134. The camera 1606 or the ultrasonic sensor 1608 may activate and obtain their results in response to closing of the lid 204. The camera 1606 or the ultrasonic sensor 1608 may also be configured to identify contamination of the refuse within the refuse container 200. The results of the position detector 1614 can indicate a location of the refuse container 200, whether the refuse container 200 has been put out, whether the refuse container 200 is in an accessible location, etc.

The power source 1604 may be charged via motion of the refuse container 200 or portions of the refuse container 200. For example, the wheels 208 may include a generator 1610 that is wired to the power source 1604 and configured to charge the power source 1604 with electrical energy as the refuse container 200 is moved and the wheels 208 are driven to rotate. The lid 204 may be coupled with the body 202 via a hinge 218. The hinge 218 may include a generator 1612 that is configured to generate electrical energy and charge the power source 1604 as the lid 204 is opened and closed by rotation about the hinge 218. The generator 1612 may also operate as a trigger or switch to activate the camera 1606 or the ultrasonic sensor 1608. The lid 204 including the components described herein may be a retrofit component that is installed onto the body 202 of the refuse container 200. In some embodiments, the wireless transceiver 1602, the power source 1604, the position detector 1614, the camera 1606, the ultrasonic sensor 1608, the generator 1612, and the generator 1610 are retrofit components. In some embodiments, the remote computing system 134 is configured to use feedback from the refuse container 200, or to implement any of the functionality or structure as described in greater detail in U.S. application Ser. No. 17/232,574, filed Apr. 16, 2021, the entire disclosure of which is incorporated by reference herein.

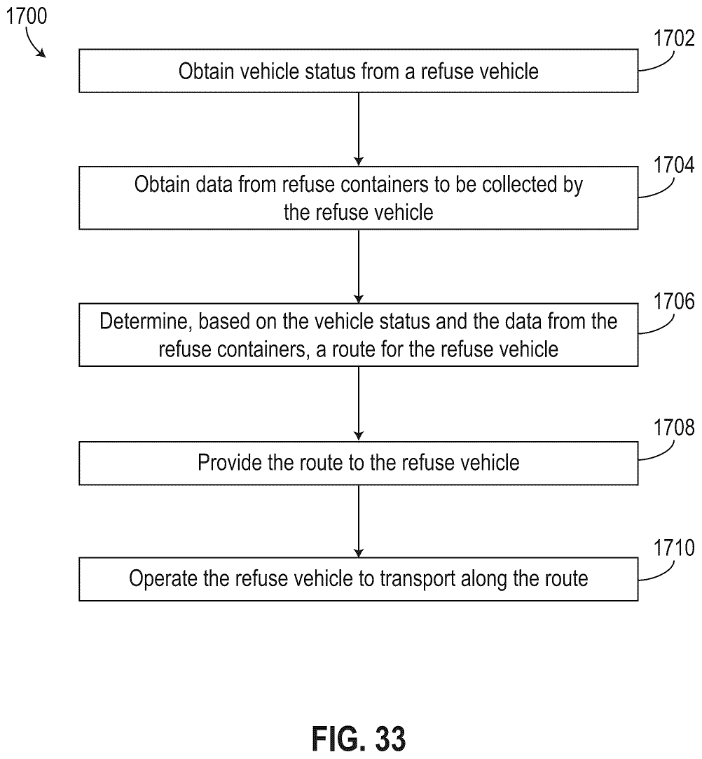

Referring to FIG. 33, a flow diagram of a process 1700 for determining a route for a refuse vehicle includes steps 1702-1710, according to some embodiments. The process 1700 can be performed by the remote computing system 134 based on feedback from telematics units 132 of the various refuse vehicles 10 and also based on feedback from refuse containers 200 in a geographic area that the refuse vehicles 10 service.

The process 1700 includes obtaining a vehicle status from a refuse vehicle (step 1702), according to some embodiments. Step 1702 may be performed by the remote computing system 134 by obtaining a current location and fill level of the refuse vehicle 10. The fill level may indicate a current amount of refuse that is present in the refuse compartment of the refuse vehicle 10.

The process 1700 includes obtaining data from refuse containers to be collected by the refuse vehicle (step 1704), according to some embodiments. The data from the refuse containers can include locations of the refuse containers 200 as well as a fill level or contamination detection of refuse in the refuse containers 200. The refuse containers 200 may include cameras or other detectors positioned in a lid of the refuse containers 200 and configured to obtain data regarding the contents of the refuse containers 200. The refuse containers 200 may establish a mesh network and can include low power Bluetooth tags.

The process 1700 includes determining, based on the vehicle status and the data from the refuse containers, a route for the refuse vehicle (step 1706), according to some embodiments. Step 1706 can be performed by the remote computing system 134 using the location, fill level, and a capacity of the refuse vehicle 10. Step 1706 may include generating a new route, or can include adjusting a current route in order to account for the remaining quantity of refuse required to be collected by the refuse vehicle 10. Step 1706 can include using the data from the refuse containers to determine a cumulative or remaining amount of refuse that is to be collected by the refuse vehicle 10.

The process 1700 includes providing the route to the refuse vehicle (step 1708) and operating the refuse vehicle to transport along the route (step 1710), according to some embodiments. In some embodiments, step 1708 includes transmitting the route to the refuse vehicle 10 via the telematics unit 132 of the refuse vehicle 10. Step 1710 can include operating a HUD of a windshield of the refuse vehicle 10 to notify an operator regarding which turns to take in real-time to transport to a next stop along the route. Step 1710 can include autonomously operating a driveline, steering system, braking system, etc., of the refuse vehicle according to the route to transport the refuse vehicle 10 along the route. Advantageously, the process 1700 uses real-time feedback from the refuse containers 200 in order to plan the routes based on detected quantities of refuse in the refuse containers 200.

### Preconditioning

Referring again to FIGS. 23-24 and 26, the refuse vehicle 10 may receive a route and a scheduled deployment time and initiate one or more preconditioning operations in order to ready the refuse vehicle 10 by the deployment time. The preconditioning operations may be initiated by the controller 102 based on a predictive model that indicates an amount of time require to ready each of the one or more systems by the scheduled deployment time. The preconditioning operations can include operating the driveline 110, the lift apparatus 116, the compaction system 118, etc., or an associated temperature control system in order to increase oil temperature to an operational level by the scheduled deployment time. The preconditioning operations can also include operating a heating ventilation and air conditioning (HVAC) system of the cab 16 of the refuse vehicle 10 such that climate in the cab 16 is at a desired or preferred setpoint by the scheduled deployment time. The preconditioning operations can also include performing a system checks procedure to identify any fault systems or components of the refuse vehicle 10. The refuse vehicle 10 may be restricted from deployment (e.g., limiting transition of the driveline 110 into a drive gear, preventing operation of the driveline 110 to transport the vehicle 10, etc.) until the system checks procedure has been completed (e.g., all the components have been checked).

In some embodiments, the controller 102 is configured to implement any of the preconditioning operations as described in greater detail in U.S. patent application Ser. No. 18/110,948, filed Feb. 17, 2023, the entire disclosure of which is incorporated by reference herein. In some embodiments, the controller 102 is configured to perform the system checks procedure by implementing any of the functionality as described in greater detail in U.S. application Ser. No. 17/232,682, filed Apr. 16, 2021, the entire disclosure of which is incorporated by reference herein. In some embodiments, in order to precondition the oil temperature, the refuse vehicle 10 and the controller 102 are configured to include and implement any of the structure or functionality as described in greater detail in U.S. patent application Ser. No. 18/131,733, filed Apr. 6, 2023, the entire disclosure of which is incorporated by reference herein.

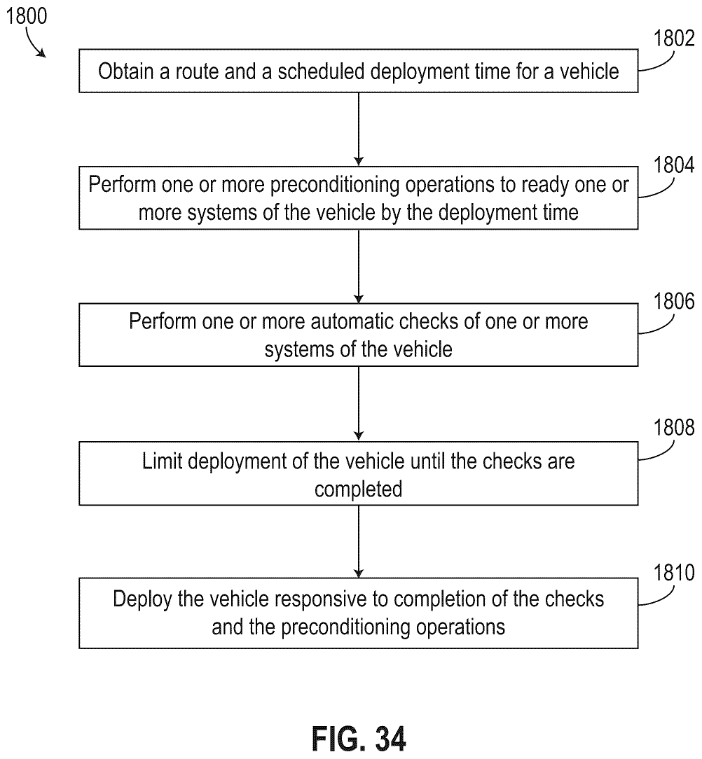

Referring to FIG. 34, a flow diagram of a process 1800 for readying the refuse vehicle 10 for deployment includes steps 1802-1810, according to some embodiments. Steps 1802-1810 can be performed by the controller 102 by operating various systems of the refuse vehicle 10 in response to receiving a route and scheduled deployment time from the remote computing system 134.

The process 1800 includes obtaining a route and a scheduled deployment time for a vehicle (step 1802), according to some embodiments. Step 1802 may be performed by the controller 102 by receiving the route and the scheduled deployment time from the remote computing system 134 via the telematics unit 132.

The process 1800 includes performing one or more preconditioning operations to ready one or more systems of the vehicle by the deployment time (step 1804), according to some embodiments. Step 1804 can include preparing oil temperatures of various hydraulic systems and preparing climate controls of the cab 16.

The process 1800 includes performing one or more automatic checks of one or more systems of the vehicle (step 1806) and limiting deployment of the vehicle until the checks are completed (step 1808), according to some embodiments. Step 1806 and step 1808 can be performed by the controller 102 by checking various systems of the refuse vehicle 10 and preventing the refuse vehicle 10 from being driven away until the checks have been completed.

The process 1800 includes deploying the vehicle responsive to completion of the checks and the preconditioning operations (step 1810), according to some embodiments. In some embodiments, step 1810 is performed by allowing the refuse vehicle 10 to be driven or transported away. In some embodiments, step 1810 includes autonomously or semi-autonomously transporting the refuse vehicle 10 out of a hub location (e.g., a garage) along the route provided in step 1802.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system, comprising:
a refuse vehicle comprising a telematics unit;
a plurality of refuse containers at a plurality of different customer locations, each of the refuse containers comprising a sensor configured to measure a fill level and a wireless transceiver;
a remote computing system comprising processing circuitry configured to:
obtain a status of the refuse vehicle from the telematics unit;
obtain sensor data from the plurality of refuse containers indicating the fill level of each of the plurality of refuse containers;
determine a route for the refuse vehicle based on the status of the refuse vehicle and the sensor data from the plurality of refuse containers; and
transmit the route to the telematics unit of the refuse vehicle.

2. The system of claim 1, wherein the status provided by the refuse vehicle comprises a fill level or payload of the refuse vehicle and a capacity of the refuse vehicle.

3. The system of claim 1, wherein the processing circuitry of the remote computing system is configured to:
obtain historical data indicating an amount of refuse in each of the plurality of refuse containers;
determine, based on the historical data, a profile indicating an average amount of refuse in each of the plurality of refuse containers and a likelihood that each of the plurality of refuse containers are contaminated; and
determine the route for the refuse vehicle based on the profile of each of the plurality of refuse containers.

4. The system of claim 1, wherein the refuse vehicle comprises a controller configured to:
obtain, from the remote computing system, a scheduled deployment time of the refuse vehicle for the route; and
perform a plurality of preconditioning operations to ready an oil temperature of a hydraulic system and an environmental condition of a cab of the refuse vehicle by the scheduled deployment time.

5. The system of claim 1, wherein the plurality of refuse containers form a mesh network.

6. The system of claim 1, wherein each of the plurality of refuse containers comprise an electrical generator operably coupled with a wheel, wherein movement of the refuse container causes the electrical generator to generate electrical energy for the sensor and the wireless transceiver.

7. The system of claim 1, wherein the remote computing system is configured to estimate a payload of the refuse vehicle at a plurality of locations along the route and determine an adjustment to a chassis of the refuse vehicle at the plurality of locations along the route based on the payload, wherein the remote computing system is configured to cause the chassis of the refuse vehicle to adjust operation according to the adjustment to the chassis.

8. The system of claim 7, wherein the adjustment to the chassis comprises at least one of a setting for regenerative braking or a pressurization of a suspension of the chassis.

9. The system of claim 1, wherein the refuse vehicle comprises a display area in a windshield of the refuse vehicle, the display area configured to provide an augmented reality overlay comprising a graphical illustration prompting a driver of the refuse vehicle to follow the route and configured to increase a conspicuity of a refuse container at an upcoming stop.

10. A method of controlling a refuse vehicle, the method comprising:
obtaining a status from the refuse vehicle;
obtaining sensor data from a plurality of refuse containers at a plurality of geographic locations, the sensor data indicating a fill level of each of the plurality of refuse containers;
determining a route for the refuse vehicle based on the status of the refuse vehicle and the sensor data from the plurality of refuse containers; and
prompting a driver of the refuse vehicle to transport the refuse vehicle along the route.

11. The method of claim 10, wherein the status provided by the refuse vehicle comprises a fill level or payload of the refuse vehicle and a capacity of the refuse vehicle.

12. The method of claim 10, further comprising:
obtaining historical data indicating an amount of refuse in each of the plurality of refuse container;
determining, based on the historical data, a profile indicating an average amount of refuse in each of the plurality of refuse container and a likelihood that each of the plurality of refuse containers are contaminated; and
determining the route for the refuse vehicle based on the profile of each of the plurality of refuse container.

13. The method of claim 10, further comprising:
obtaining a scheduled deployment time of the refuse vehicle for the route; and
performing a plurality of preconditioning operations to ready an oil temperature of a hydraulic system and an environmental condition of a cab of the refuse vehicle by the scheduled deployment time.

14. The method of claim 10, further comprising:
estimating a payload of the refuse vehicle at a plurality of locations along the route;
determining an adjustment to a chassis of the refuse vehicle at the plurality of locations along the route based on the payload; and
adjusting operation of the chassis of the refuse vehicle according to the adjustment at the plurality of locations along the route.

15. The method of claim 14, wherein the adjustment to the chassis comprises at least one of a setting for regenerative braking or a pressurization of a suspension of the chassis.

16. The method of claim 10, further comprising:
operating a display area in a windshield of the refuse vehicle to provide an augmented reality overlay comprising a graphical illustration prompting the driver of the refuse vehicle to follow the route and configured to increase a conspicuity of a refuse container at an upcoming stop.

17. The method of claim 10, further comprising:
quarantining a customer from the route in response to detecting a quarantined object based on the sensor data or image data obtained from a camera of the refuse vehicle.

18. A system, comprising:
a refuse vehicle; and
processing circuitry configured to:
obtain a status of the refuse vehicle;
obtain a fill level of each of a plurality of refuse containers;
determine a route for the refuse vehicle based on the status of the refuse vehicle and the sensor data from the plurality of refuse containers; and
transmit the route to the refuse vehicle.

19. The system of claim 18, wherein the fill level is obtained from sensor data received from the plurality of refuse containers indicating the fill level of each of the plurality of refuse containers, or from historical data of the plurality of refuse containers.

20. The system of claim 18, wherein the processing circuitry is further configured to:
estimate a payload of the refuse vehicle at a plurality of locations along the route;
determine an adjustment to a chassis of the refuse vehicle at the plurality of locations along the route based on the payload; and
adjust operation of the chassis of the refuse vehicle according to the adjustment at the plurality of locations along the route.
